(19) United States
(12) Patent Application Publication
(10) Pub. No.: US 2012/0221547 A1
(43) Pub. Date: Aug. 30, 2012

(54) Method and System for Automated Search for, and Retrieval and Distribution of, Information

(75) Inventors: Stephen G. HALL, Bainbridge Island, WA (US); Thomas A. McCann, III, Seattle, WA (US); Timothy David CASE, Anaheim, CA (US); Adam LOVING, Seattle, WA (US); Matthew HARTZLER, Kirkland, WA (US); Tobias James Padilla, London (GB)

(73) Assignee: GIST INC. FKA MINEBOX INC., Seattle, WA (US)

(21) Appl. No.: 13/405,105

(22) Filed: Feb. 24, 2012

Related U.S. Application Data
(63) Continuation of application No. 12/070,348, filed on Feb. 14, 2008.

(51) Int. Cl. G06F 17/30

(52) U.S. Cl. 707/710; 707/E17.005; 707/E17.108

(57) ABSTRACT

Embodiments of the present invention are directed to automated information-search and information-retrieval systems that provide information, on a continuous or periodic basis, to users or subscribers. In one embodiment of the present invention, information is gathered from a user's computer, or from computers accessible from the user's computer, on an essentially continuous basis in order to provide a database of information from which meaningful and focused search queries can be automatically constructed. The search queries are then employed to find, on behalf of the user or subscriber, current information useful to, and needed by, the user or subscriber.

### CROSS-REFERENCE TO RELATED APPLICATIONS

This application is a continuation application of U.S. patent application Ser. No. 12/070,348 filed on Feb. 14, 2008, said application is expressly incorporated by reference herein in its entirety.

### TECHNICAL FIELD

The present invention is related to information-retrieval systems and information-management systems and, in particular, to various methods and systems that automatically generate focused search criteria on behalf of a user or subscriber in order to retrieve information using the search criteria for the user or subscriber on a continuous, periodic, or on-demand basis.

### BACKGROUND OF THE INVENTION

The development and evolution of computers, operating systems, electronic communications, database-management software, computer hardware systems, and the Internet have, during the past 50 years, radically altered the availability, quality, and quantity of information accessible to the general public. In particular, those owning, or having access to, personal computers, work stations, and other user-friendly computational devices currently have access to enormous amounts of information. The radical and pervasive changes in the information-storage and information-distribution systems in society can be seen in almost every facet of human endeavor and human interaction. For example, even 20 years ago, it was common to use large, physical indexes containing thousands of printed cards in order to locate books in libraries. Today, most libraries employ personal-computer-based book-location software. While encyclopedias and library reference-book departments formerly served as the primary information sources for students and professionals, today's personal-computer user, equipped with a web browser, can quickly and easily access many orders of magnitude greater amounts of information than could be accessed using reference-book sections and on-line information sources of even large, university libraries 30 years ago. Indeed, as shown in FIG. 1, a personal computer connected to the Internet and equipped with a web browser can literally access the world. The Internet interconnects millions of computers, from personal computers to huge computational centers containing banks of high-end computer systems and data-storage arrays of immense capacities. The user can access hundreds of millions to billions of different web pages hosted by at least hundreds of thousands of server computers throughout the world. The amount of high-quality information available to a computer user through the Internet is already staggering, and the amount of available information appears to be growing at least at geometric rates.

While a huge amount of information is accessible to a user, the task of finding particular information is often quite tedious and difficult. Computer users typically employ a web browser connected to a remote, commercial search engine in order to search for particular information. FIG. 2 shows a screen capture of a common search-engine web page as rendered by a commonly-available web browser to the user of a personal computer. For any displayed web page, the browser includes the universal resource locator (“URL”) 204 of the displayed web page and provides various tools and features in a tool-and-feature area 206 that may be employed by a web-browser user to locate web pages, configure the web browser, and carry out other useful tasks and operations.

In the screen capture shown in FIG. 2, the home Yahoo® search engine page 208 is currently displayed by the web browser. The search-engine page also provides a variety of features 210 and automatically provides various different types of information, including current news headlines 212, advertisements 214, and other information 216. For most users, the most important feature of the search-engine web page is the text-input window 218 and web-search-invocation button 220 at the top of the web page. The text-input window allows a user to enter a text-based query, and the web-search-invocation button allows the user to then invoke a search of the world-wide web for web pages related to the query. FIG. 3 illustrates a web-page search. As shown in FIG. 3, a user wishing to know the total number of web pages available on the Internet might enter the text “total number of web pages” 302 into the text-input window 218 and then invoke a world-wide-web search based on this query. FIG. 4 shows a displayed web-age result. As shown in FIG. 4, the remote search engine in response to the search request, returns a first web page of a large number of web pages containing the search results. The search results comprise a list 402 of links to web pages relevant to the query “total number of web pages.” As reported by the search engine 404, the search engine identified an enormous number of web pages related to the query “total number of web pages.” A search engine attempts to order these web pages with respect to relevance or significance to the query terms, and presents, to the user, the most relevant web pages in the first web page 406 returned in response to the user's query. Were the user to have infinite time and patience, the user could successively scan many pages of annotated links to other web pages relevant to the search query. FIG. 5 illustrates difficulties associated with web-page searching. As illustrated in FIG. 5, the text-based-query, search-engine-based information search method provided currently by search engines can often be far more difficult and tedious than finding the proverbial needle in a haystack. In essence, the search engine provides a comprehensive list 502 of potentially related web pages, and the user is then required to read the annotations included with the links by the search engine, or to successively access 504 each of the referenced web pages through a browser, in order to attempt to find the information sought by the user. In the example of FIGS. 2-5, the user is interested in the total number of web pages currently available on the Internet. However, none of the annotated links shown in FIG. 4 are related to this question. While a user may attempt to refine a query to more particularly search for desired information, so that searches conducted on the refined query provide fewer result links that are more particularly related to the refined search question, it is often quite difficult to pose queries that produced desired results in an efficient manner. Moreover, as queries are increasingly refined, a series of searches based on the increasingly refined queries may become too narrow to capture potentially useful information, and may lead the user away from large numbers of web pages that contain relevant information. Despite these well-recognized problems and disadvantages of current web-search-engine-based information-searching techniques, users adept at text-based searching can nonetheless often quickly and effectively obtain desired information on almost any topic. Thus, web-search engines represent an enormous advance in information-search and information-retrieval capabilities accessible to the general population.

Difficulties and disadvantages associated with web-search-engine-based information searching and information retrieval have long been recognized, and have served as the motivation for enormous research-and-development efforts to provide better Internet-based information-searching and information-retrieval tools. An enormous amount of research-and-development effort is currently devoted to the so-called “semantic web,” a collection of ideas involving, among other things, incorporating natural-language capabilities in search engines so that, rather than searching based on query-term-occurrence frequencies, search engines can transform queries into concepts and identify web pages related to those concepts. For example, in the above example, an advanced search engine would parse the query phrase “total number of web pages” to identify the concept to which the query is directed, rather than simply looking for pages that contain occurrences of the individual words “total,” “number,” “web,” and “pages.” When the search engine has, in advance, indexed the available web pages with respect to concepts, rather than to word occurrence statistics, the search engine may be able to immediately identify a much smaller number of web pages that are much more highly related to the conceptual query than is possible using query-term-occurrence-based searching techniques. Alternatively, by deriving the underlying concept, the search engine may even be able to carry out an automated text-based search more quickly, and with greater precision, than a human user can search by remote access to the search engine through the search-engine web page. Unfortunately, natural-language processing is computationally intensive and, so far, falls far short of accurately identifying concepts from text-based queries.

Eventually, natural-language processing and intelligent searching may provide enormous efficiencies and capabilities to users, but currently, only incremental advances are being made. However, with the ever-increasing amount of information available through the Internet, and. with rapidly increasing demands for information searching and information retrieval in the workplace and in many other human activities, information providers, computer-application designers and vendors, and users of computers and web-search engines have all recognized the need for more time-efficient and focused methods and systems for retrieving information on behalf of computer users.

### SUMMARY OF THE INVENTION

Embodiments of the present invention are directed to automated information-search and information-retrieval systems that provide information, on a continuous or periodic basis, to users or subscribers. In one embodiment of the present invention, information is gathered from a user's computer, or from computers accessible from the user's computer, on an essentially continuous basis in order to provide a database of information from which meaningful and focused search queries can be automatically constructed. The search queries are then employed to find, on behalf of the user or subscriber, current information useful to, and needed by, the user or subscriber.

### BRIEF DESCRIPTION OF THE DRAWINGS

FIG. 1 illustrates a personal computer connected to the Internet and equipped with a web browser.

FIG. 2 shows a screen capture of a common, search-engine web page as rendered by a web browser to the user of a personal computer.

FIG. 3 illustrates a web-page search.

FIG. 4 shows a displayed web-age result.

FIG. 5 illustrates difficulties associated with web-page searching.

FIG. 6 illustrates a general approach to information retrieval and information distribution that underlies many embodiments of the present information.

FIG. 7 illustrates an overall automated-information-provision strategy that underlines methods and systems of the present invention with respect to a particular user.

FIGS. 8A-D illustrate various types of information available on, and collected from, a user's computer, computers accessible from a user's computer, and other sources that may be used to subsequently generate search queries according to embodiments of the present invention.

FIGS. 9A-K illustrate a number of relational-database tables that together comprise a database for one embodiment of the present invention.

FIG. 10 provides a control-flow diagram that illustrates, at a high level, operation of the server of an information-provision service that represents one embodiment of the present invention.

FIG. 11 provides a control-flow diagram for the registration process, as carried out by an information-provision-service server that represents one embodiment of the present invention.

FIG. 12 provides a control-flow diagram for an extractor executable downloaded by the information-provision service to the computer of a user of, or subscriber to, an information-provision service that represents one embodiment of the present invention.

FIG. 13 provides a control-flow diagram for the routine “upload,” called in steps 1204 and 1210 of FIG. 12.

FIG. 14 provides a control-flow diagram for the routine “add calendar event to bundle,” called in step 1307 of FIG. 13.

FIG. 15 provides a control-flow diagram for the routine “add email message to bundle,” called in step 1308 in FIG. 13.

FIGS. 16-18 provide control-flow diagrams for reception and processing of extractor-transmitted information bundles by the information-provision service.

FIGS. 19-20 provide control-flow diagrams for the news-harvester process that runs on the in information-provision-service server.

FIG. 21 illustrates the importance or relevance ranking computed by the information-provision service.

FIG. 22 shows various types of information stored in, or that can be inferred from, data stored in the above-described database used to compute relevance or importance.

FIG. 23 shows a state-transition diagram that illustrates the web pages provided to a user by an information-provision service and the various ways in which a user navigates through the web pages in order to obtain important and relevant information from, and provide feedback to, the information-provision service, according to one embodiment of the present invention.

FIG. 24 shows a screen capture of a dashboard page, the central web page of the web-page-based dialog discussed with reference to FIG. 23 and the initial web page displayed to a user who requests information, according to one embodiment of the present invention.

FIG. 25 shows a person-detail page that may be displayed to a user when the user inputs a mouse click to a person listed on the dashboard page, or in response to a specific request by a user for information about the person, according to one embodiment of the present invention.

FIG. 26 illustrates. a social graph for a person provided by the information-provision service according to one embodiment of the present invention.

FIGS. 27 and 28 shows a company-configuration page and a person-configuration page, respectively, according to one embodiment of the present invention.

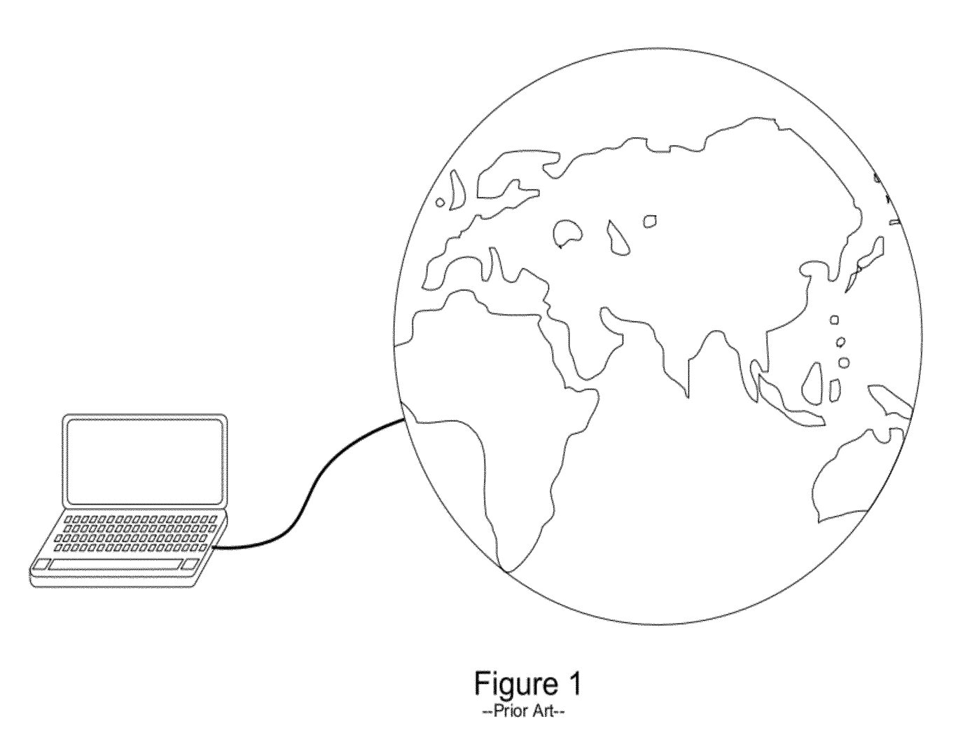

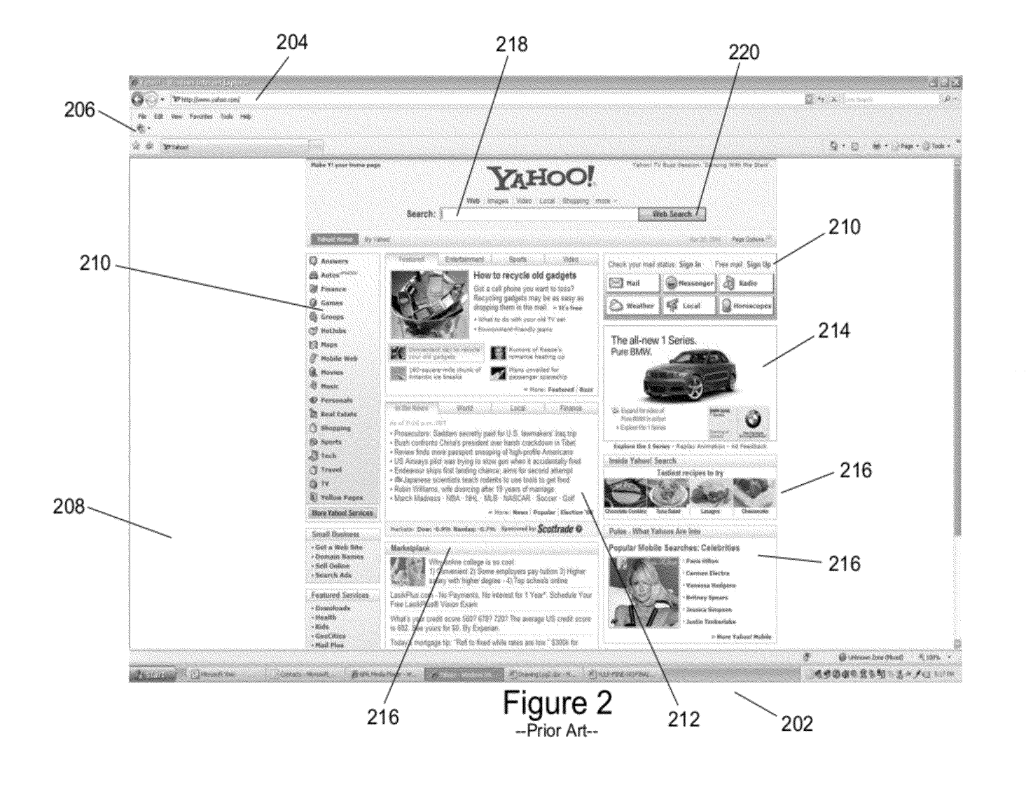

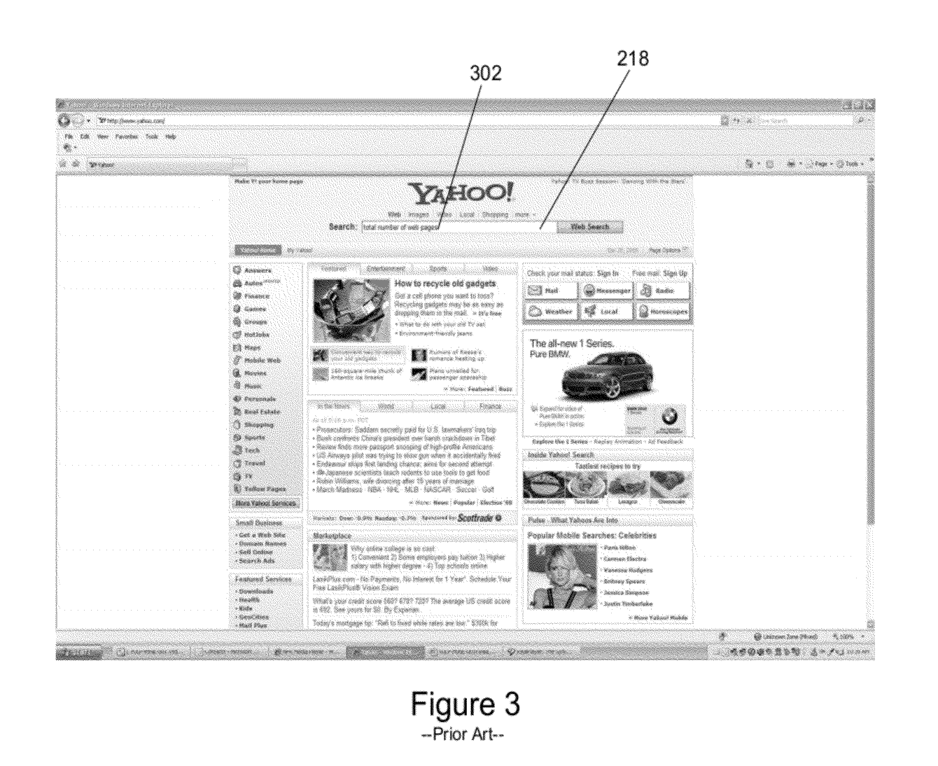

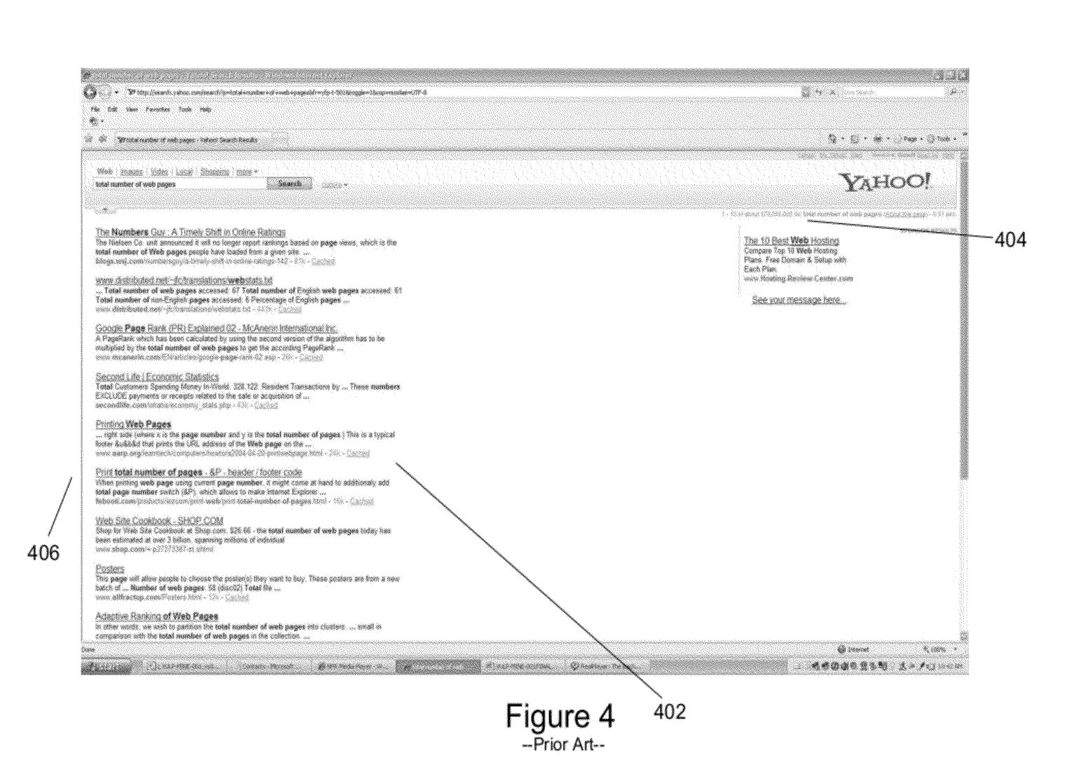

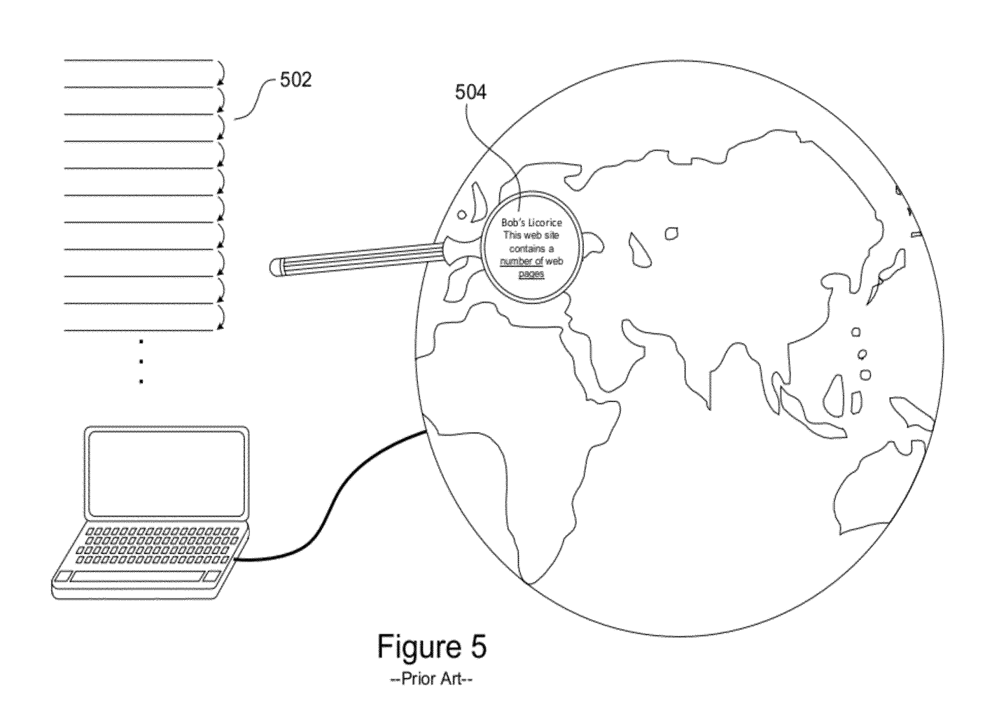

### DETAILED DESCRIPTION OF THE INVENTION

The present invention comprises a family of methods and systems for automatically searching for, and retrieving, information on behalf of users or subscribers of an information-provision service. Unlike many narrowly focused information-provision services, such as automatic stock-quote systems or notification of newly available items for sale by Internet-based sales sites, users of which specify, in advance, the particular types of information that they wish to receive, the method and system embodiments of the present invention automatically determine the types of information needed by, or useful to, a user or subscriber on a continuous or periodic basis, and then automatically provide information retrieved from various information sources that correspond to the determined types of information needed by, or useful to, a user or subscriber. Method and system embodiments of the present invention are therefore far easier to configure and use than information services that require users or subscribers to predefine the types of information that they wish to receive. Furthermore, the system embodiments of the present invention search far more comprehensively over a far greater amount of information generally obtained from multiple sources. There are many additional advantages to the information-provision approaches that represent embodiments of the present invention. For example, the method and system embodiments of the present invention can often automatically determine the types of information useful to, or needed by, a user or subscriber before the user or subscriber would otherwise be aware of the utility or necessity of the information. Moreover, these determinations are generally made on a continuous or periodic basis, so that the information provided to a user closely tracks the user's or subscriber's current activities, interests, and needs.

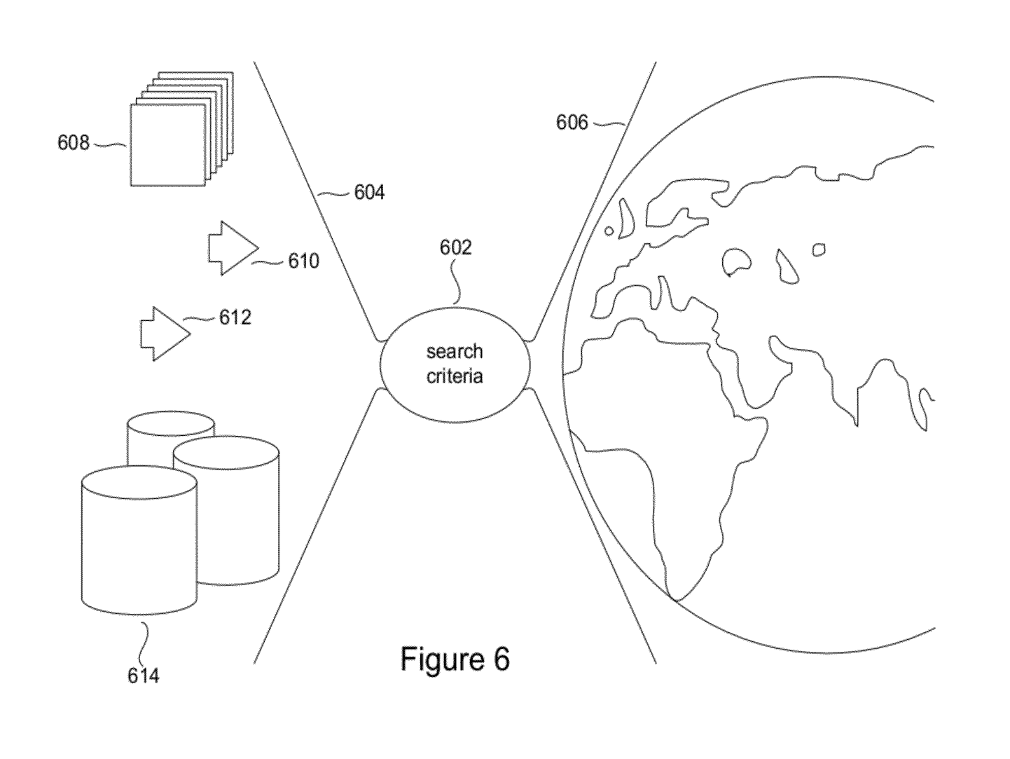

FIG. 6 illustrates a general approach to information retrieval and information distribution that underlies many embodiments of the present information. Information retrieval occurs, according to certain embodiments of the present invention, in two phases. In a first phase, a variety of different information sources are employed in order to automatically generate search criteria 602 for each user or subscriber. In the second phase, the search criteria are then used to search many. different sources of information, including the Internet. In other words, a variety of information sources are monitored and funneled 604 into a search-criteria or search-query generation process 602, and then, using the generated search criteria or search queries, an expansive search 606 can be automatically carried out in order to retrieve information needed by, and useful to, a particular user or subscriber and provide that information to the user or subscriber on a continuous or periodic basis. By separating the information-retrieval task into these two phases, an otherwise difficult or practically impossible problem is made tractable. For example, when users are required to predefine the types of information that they wish to receive, users risk inadvertently omitting types of information that would be useful to the users and risk under-constrained queries that return far too much information to the user. Starting from all information available on the Internet and other sources, and attempting to filter or winnow that information down to a set of information useful to, and needed by, a particular user is an exceedingly difficult, and generally practically impossible, task. By automatically generating well-defined and well-constrained search criteria 602, subsequent information retrieval becomes efficient and tractable.

Many different sources of information may be used in order to automatically determine search criteria. These sources included email messages sent and received by a user or subscriber and calendar events stored in a user or subscriber's electronic calendar 608, information from various sources previously accessed by a user or subscriber 610, any of various other types of information sources 612, and comprehensive, stored information 614 including past user or subscriber's activities, stated preferences or selections, compiled statistics related to various subjects of interest to a user or subscriber, and other stored information. All of the information sources 608, 610, 612, and 614 can be analyzed in order to determine an importance-ordered list of various topics of current interest to, or currently needed by, a particular user or subscriber. This importance-ordered list can then be used as the basis for generating queries for seeking information about some number of the most highly ranked subjects of interest, and these queries are then employed to search a wide variety of information sources for information related to these subjects of interest. The information is then provided to a user or subscriber on-demand, automatically on a periodic or continuous basis, or both on-demand and automatically.

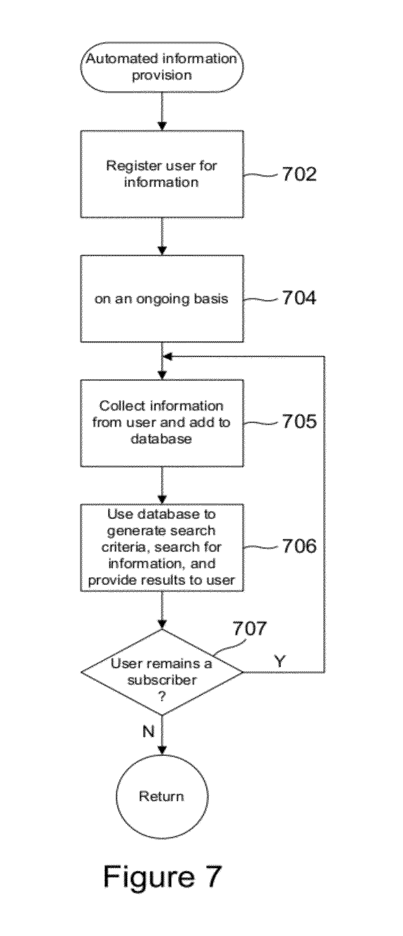

FIG. 7 illustrates an overall automated-information-provision strategy that underlines methods and systems of the present invention with respect to a particular user. First, in step 702, the user is registered for information provision. In many cases, registration occurs as a result of a request by a user to subscribe to an information service. In response to the request, an automated-information-provision system undertakes a registration process in which information is collected from the user. In cases where information is provided for a fee, a fee-payment protocol may be initialized during the registration process, such as periodic charges to a credit card or transfers from a bank account. Once a user is subscribed, then the while-loop of steps 704-707 is continuously iterated on behalf of the user by the automated information-provision system. In step 705, information is automatically collected from the user's computer, computers accessible from the user's computer, and possibly from other information sources, and the collected information is processed and added to a database. In step 706, the information stored in the database is used to generate search criteria or search queries used to search the Internet and other information not necessarily ordered, with respect to one another, as shown in FIG. 7. Information collection and information provision may occur in parallel, for example, and may be undertaken according to different considerations at different times. For example, information collection from a user's computer and other information sources, in step 705, may be carried out periodically according to predetermined information-collection intervals. By contrast, searching for information on behalf of a user or subscriber may also be carried out automatically, at predetermined intervals, or may be carried out in an on-demand fashion, in response to requests for information from the user.

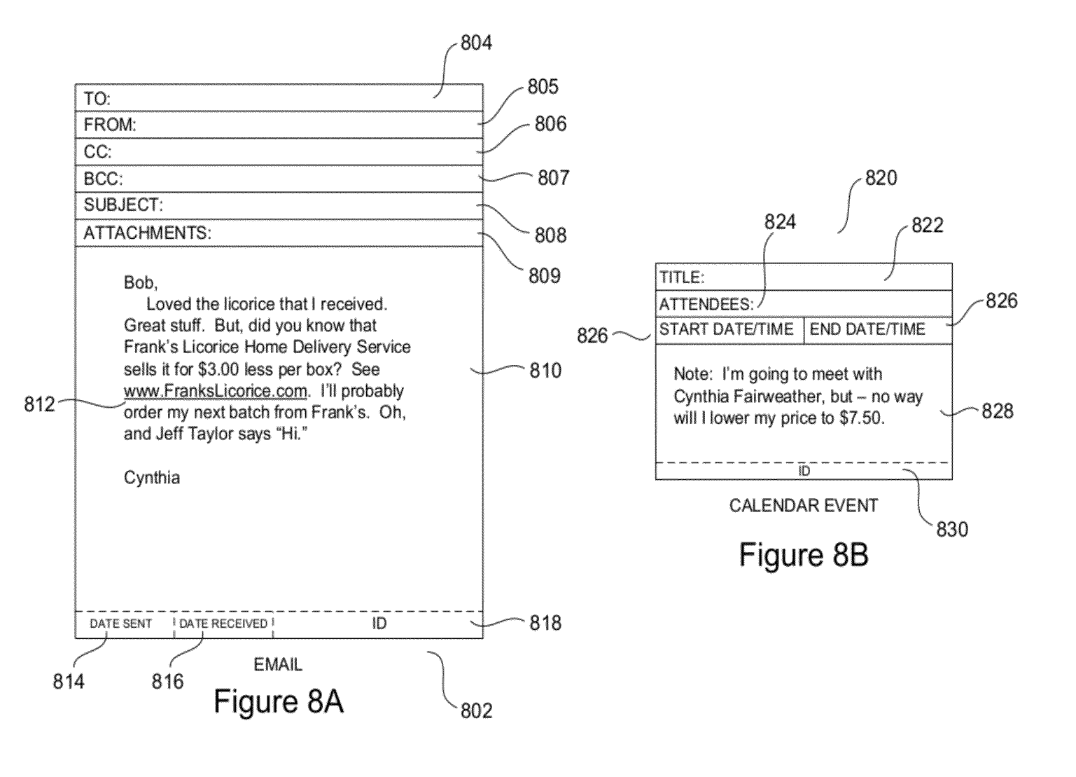

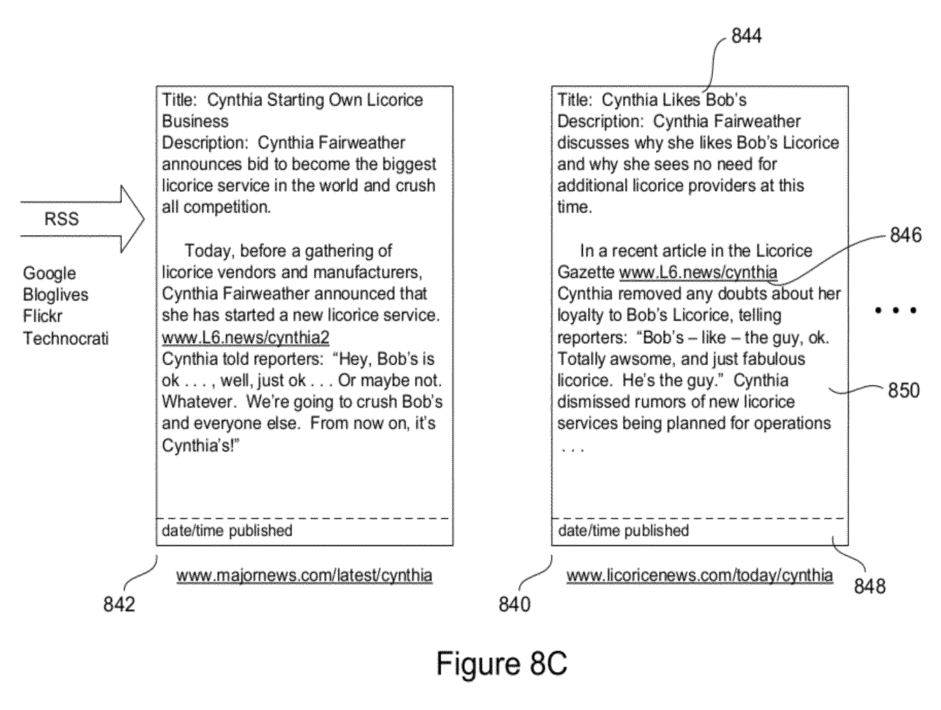

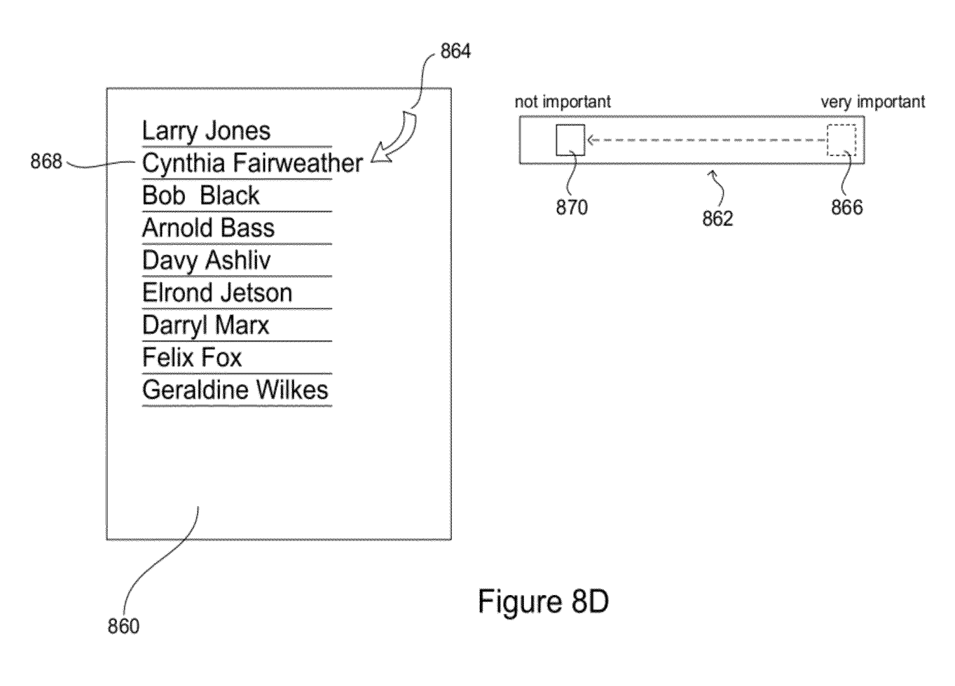

FIGS. 8A-D illustrate various types of information available on, and collected from, a user's computer, computers accessible from a user's computer, and other sources that may be used to subsequently generate search queries according to embodiments of the present invention. The information may be used, in addition, to generate ordered lists of subjects, information about which is useful to, or needed by, a user or subscriber of an information service, as discussed below. A first type of useful information includes stored email messages sent and received by a user or subscriber, 802 in FIG. 8A. Email messages are generally stored in specially formatted files, databases, or other information-storage facilities resident on a user's computer system or on another computer system accessible through the user's computer system, such as an email server. An email message contains many pieces of useful information, including: (1) the email address or addresses of those to whom the email message was sent 804; (2) the email address of the message's sender 805; (3) the email address or addresses of those cc'd when the email message was sent 806; (4) the email address or addresses of those blind copied when the email was sent 807; (5) a text field that includes the subject or title of the email 808; (6) a list of attachments included with the email, such as text-based documents, pictures and graphics, PowerPoint presentations, and other such attachments 809; (7) a message body 810 that may include text and links, such as link 812, to web pages, server computers, and other such entities 810; and (8) a number of data items normally not displayed as part of the email message, including a date/time that the email was sent 814, a date/time that the email was received 816, and an email-message ID 818 generated by an email application program. Stored email messages are particularly valuable for identifying people and organizations important to a particular user or subscriber of an information service. As one example, it is logical to infer that those people with whom a user or subscriber most frequently corresponds via email are the people most important to the user and are therefore the people about which the user or subscriber would desire to have any currently available information. Similarly, companies most frequently linked through email messages sent and received by a user or subscriber can logically be inferred to be those companies most important to a user or subscriber, and about which the user or subscriber most desires any additional information that can be found and delivered to the user or subscribed by an information-provisioning system. In certain embodiments, natural-language-processing routines may be employed to mine useful information, including valuable search terms, from the text included as an email-message body. Natural-language-processing routines may, for example, identify the names of important people and companies, and attributes related to those people and companies that are useful for generating search queries.

Another valuable source of information regarding a user's or subscriber's information needs is the contents of an electronic calendar residing in, or accessible from, a user's or subscriber's computer FIG. 8B shows an exemplary calendar event that may be stored in a calendar file or database on a user's computer, or on a computer accessible from a user's computer. The calendar event 820 includes: (1) a title 822 that contains text describing the event, such as the subject matter for a meeting or conference; (2) a list of the email addresses of attendees of the meeting or conference 824; (3) start date/time and end date/time for the meeting or conference 826; (4) additional notes or comments with regard to the meeting 828; and (5) an event ID generated by a calendar application 830. Like email messages, calendar events may provide accurate indications of the importance of various people and companies to a user or subscriber. For example, it can be logically inferred that those people attending meetings and conferences most frequently in common with a user or subscriber may be the people most important to the user or subscriber. In certain embodiments, natural-language-processing routines may be employed to mine useful information, including valuable search terms, from the text included as user-input notes or observations related to calendar events. Natural-language-processing routines may, for example, identify the names of important people and companies, and attributes related to those people and companies that are useful for generating search queries.

FIG. 8C shows an additional information source that may be mined, by various system embodiments of the present invention, for information related to a user's or subscriber's current information needs, as well as a source of information for provision to users and subscribers. Various news services, including Google, B1oglines, Filch, and Technorati, provide RSS newsfeeds to requesters. Upon request, an RSS service provides XML documents that contain condensed news stories. For example, in FIG. 8C, a first news-containing XML document 840 and a second news-containing XML document 842 are the most recent news-containing XML documents obtained from a particular RSS feed. The news items contained in the RSS-provided XML documents may include titles 844, links 846 to photographs, websites, and other external information, an indication of the date/time that the news was published 848, and the text-based narratives corresponding to the news items 850. These news items can be mined for references to people, companies, and other subject matter of potential interest to a user or subscriber. Similarly, once search criteria are generated for a particular user or subscriber, RSS feeds are sources of information that can be searched for particular information items of interest to a particular user or subscriber.

FIG. 8D shows an example of user-supplied preferences, indications of importance, and other information. In various responses to user requests, an. information-provision service may provide ordered lists of people, companies, and other subjects that may be of interest to the user or subscriber 860. The relative importance of the subjects to the user may be shown by a sliding scale feature, such as sliding scale feature 862 that is displayed when a user moves a cursor 864 over a particular list entry. The scale may display a system-generated importance 866, and may also allow a user to adjust that importance explicitly, by moving the importance indicator along a sliding scale. For example, in FIG. 8D, a user has changed the importance level associated with the second entry 868 in a displayed list from “very important” 866 to “not important” 870. Many other types of user input may be solicited by an information-provision system. As an example, a user may indicate a level of interest in particular news items, companies, and other subject matters, and may similarly provide indications of the importance or relevance of particular emails, calendar events, and other such information. A user may also specify preferences or configuration parameters.

The example information sources shown in FIGS. 8A-D, and discussed with reference to those figures, are but a few of the many possible different types of information that can be automatically and continuously or periodically collected from a user or subscriber's computer, or from computers accessible through the user's or subscriber's computer, by an information provision system representing an embodiment of the present invention. Additional information sources may include text documents, presentations, images, and other such information-containing entities prepared by, or received and stored by, a user or subscriber, activities and tasks carried out by the user or subscriber, searches carried out by the user or subscriber, search results returned to the user or subscriber by any of various search engines and other search applications, and a wide variety of additional information.

Next, a set of tables representative of the data collected from users and subscribers of an information-provision service are described, as one example of the database maintained by an information-provision service for generating search queries to find relevant information to return to users or subscribers. The tables are described as relational-database tables that are created and updated using commonly available SQL commands, often embedded in procedural programming languages. Each row in a relational-database table is essentially an entry, or record. Rows may be inserted into a table, deleted from a table, and modified, in place, within a table. SQL provides a rich set of operations that allow particular rows, and subsets of rows, in tables to be located via SQL queries. Queries can be directed to single tables, or to multiple tables through join operations.

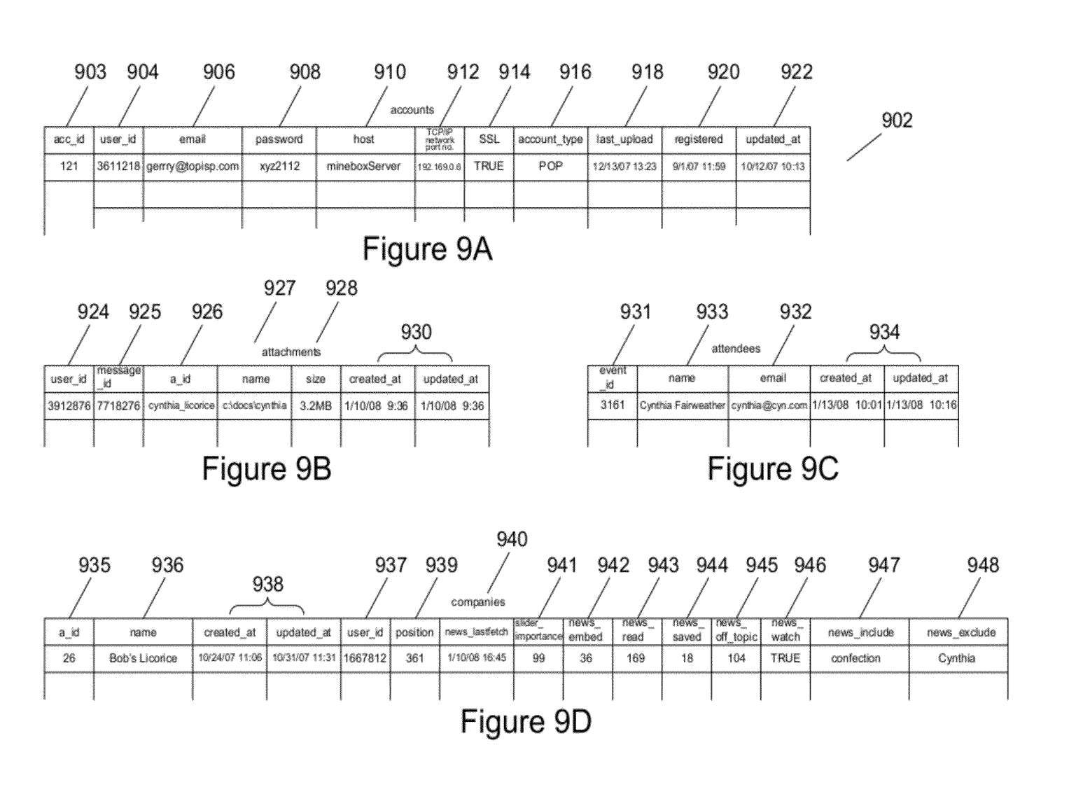

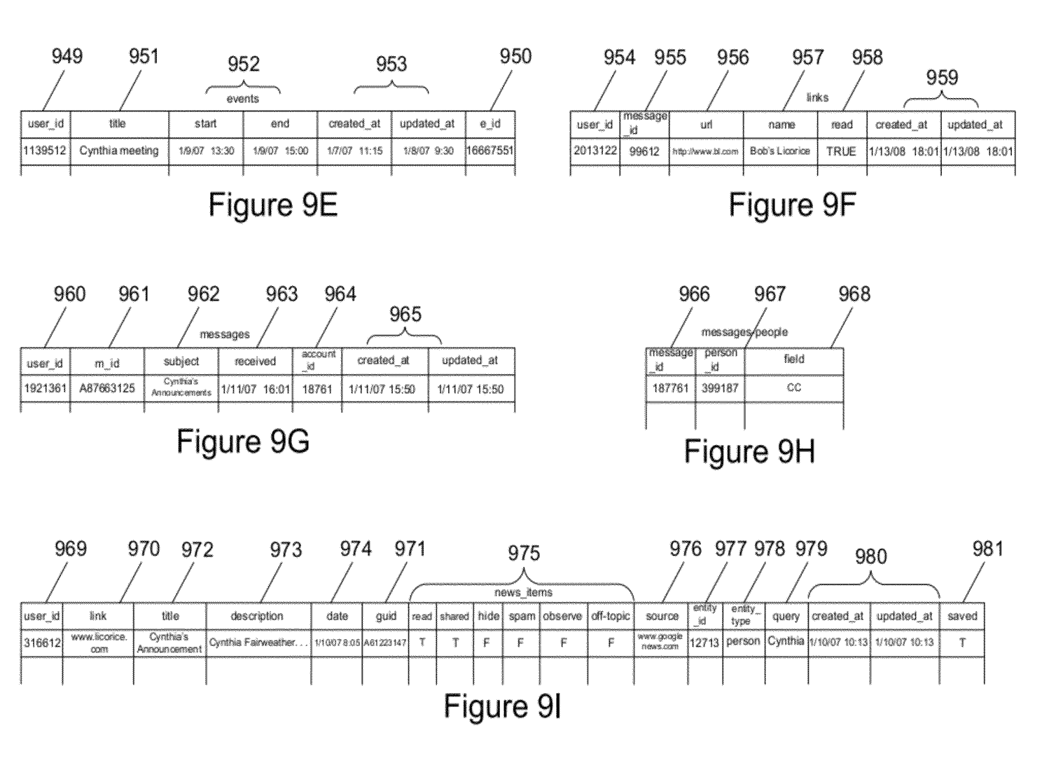

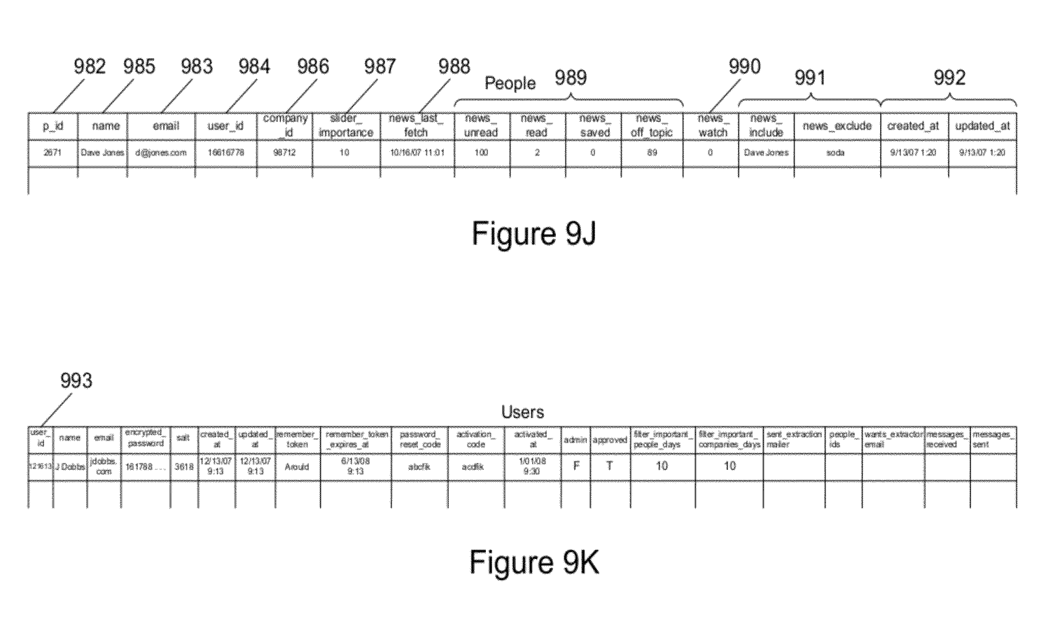

FIGS. 9A-K illustrate a number of relational-database tables that together comprise a database for one embodiment of the present invention. FIGS. 9A-K illustrate 11 relational-database tables that together comprise a database for one embodiment of the present invention that accumulates data mined from email messages, calendar events, RSS feeds, and user input to provide current information about people and companies of importance to particular users and subscribers. The tables are shown with on representative row, or entry, in FIGS. 9A-K, but, in an actual database, tables may have hundreds, thousands, millions, or more entries.

The Accounts table, shown in FIG. 9A, includes one entry, or row, for each email address associated with a user or subscriber of an information-provision service. The user is identified by a user ID that is generated by the information-provision service when a user is registered. Thus, the user_ID field 904 and email-address field 906 together comprise a unique value, or key, for each entry in the Accounts table. Alternatively, an account ID generated by the information-provision service to uniquely identify each account and stored in an acc_id 903 field may serve as a unique key. The remaining fields in each row of the Accounts Table include additional information used to manage connection of users to the information-provision service. These fields include: (1) password 908, a password used by a user or subscriber to directly connect to an information-provision-service server; (2) host, the name of a server or computer from which email can be uploaded; (3) TCPUIP_network_port_number 912, the port number used by the server or computer; (4) SSL 914, a Boolean field indicating whether or not the Secure Sockets Layer protocol could be used to connect to the server; (5) account_type 916, an indication of the type of communications service used to connect to server or computer, such as “POP” or “Gmail”; (6) last_upload 918, the date/time when email messages were last extracted and uploaded from the user's email address; (7) registered 920, the date/time when the user or subscriber was registered; and (8) updated_at 922, the date/time when the entry of the Accounts table was last modified. Thus, all of the email addresses used by a particular user or subscriber, from which email messages are downloaded by the information-provision service, can be found by selecting all entries of the Accounts table with a value in the user_ID field equal to the user ID of a particular user or subscriber. In certain embodiments of the present invention, each user email account is treated as a separate and distinct account, while in other embodiments, all of the email addresses corresponding to a particular user or subscriber are collectively treated as a single account.

The Attachments table, shown in FIG. 9B, includes one row, or entry, for every attachment found associated with any email downloaded by the information-provision service from any subscriber or user. Each row in the Attachments table is uniquely identified by values stored in the combination of fields user_ID 924 and message_ID 925, or by the value stored in an attachment-ID field, a_ID 926. In certain embodiments, the attachment ID stored in the field a_ID may be a unique identifier for any row in the table Attachments, while, in other embodiments, the attachment ID may be unique only for rows associated with a given user or subscriber, in which case the attachment ID cannot, by itself, server as a unique identifier. Additional fields in each row of the table Attachments includes: (1) name 927, the name of the attachment; (2) size 928, the size, in bytes, of the attachment; and (3) created_at and updated_at 930, the date/time of creation and the date/time of last modification of the row, respectively.

The table Attendees, shown in FIG. 9C, includes an entry for each email address included in a calendar event downloaded by the information-provision service. Each row in the table Attendees is uniquely identified by the values in the pair of fields event_ID 931 and email 932. Additional fields in each row of the table Attendees include: (1) name 933, the name of the attendee; and (2) created_at and updated_at 934, the date/times of creation and last modification of the row.

The table Companies, shown in FIG. 9D, includes an entry for each. company or organization identified by the information-provision service from information uploaded from users and subscribers. Each row in the table Companies is uniquely identified by the values in the pair of fields name 936 and user_ID 937. Thus, for any given company, there is a separate entry in the table Companies for each user or subscriber for which the company has been identified as being relevant or important. Additional fields in each row of the table Companies include: (1) created_at and updated_at 938, the date/times of creation and last modification of the row; (2) position 939; (3) news_last_fetch 940, the date/time when a search was last undertaken for information related to the company; (4) slider_importance 941, the user-assigned importance or relevance for the company; (5) news_unread 942, the number of new items related to this company provided to, but not accessed by, the user or subscriber; (6) news_read 943, the number of news items provided to, and read by, the user or subscriber; (7). news_saved 944, the number of news items provided to and saved by the user or subscriber; (8) news_off topic 945, the number of news items provided to, and designated “off topic” by, the user or subscriber; (9) news_watch 946, a Boolean field indicating whether or not the company presented by a row in the table Companies should serve as the subject for additional news searches; (10) news_include 947, a list of terms that should be positively matched in news items returned by searches; and (11) news_exclude 948, a list of terms that should not occur in news items returned by searches for news related to the company represented by a row in the table Companies.

The table Events, shown in FIG. 9E, includes a row for each event uploaded from an electric calendar residing on, or accessed through, any user's or subscriber's computer. Each row in the table Events is uniquely identified by values in the pair of fields user_ID 949 and e_ID 950, an event identifier extracted from the event. Additional fields in the table Events include: (1) title 951, the title for the meeting or conference represented by the event; (2) start and end 952, the date/times of the beginning and ending of the conference or meeting represented by the event; and (3) created_on and updated_on 953, the date/times when the row of the table Events was created and last modified, respectively.

FIG. 9F illustrates the table Links. Each entry, or row, in the table Links represents a link downloaded from each processed email message or calendar event. Each row in the table Links is uniquely identified by the values in the three fields user_ID 954, message_ID 955, and URL 956. Additional fields in each row of the table Links include: (1) name 957, a name parsed from the link; (2) read 958, a Boolean field indicating whether or not a user has accessed the web page or web site referenced by the link; and (3) created_at and updated_at 959, the date/times that the row was created and last modified, respectively.

The table Messages is illustrated in FIG. 9G. Each row in the table Messages represents an email message downloaded by the information-provision service from any user or subscriber. Each row, or entry, in the table Messages is uniquely identified by the values in the pair of fields user_ID 960 and m_ID 961. Additional fields in the table Messages include: (1) subject 962, the text included in the subject field of the email message; (2) received 963, the date/time that the user or subscriber received the email message; (3) account_ID 964, an identifier of the email account from which the message was extracted; (4) created_at and updated_at 965, the date/time that the row was created and last modified, respectively.

The table Messages_people, shown in FIG. 9H, includes an entry for each person associated with each email message accessed by the information-provision service. Each row in the table Messages_people is uniquely identified by the values in the pair of fields message_ID 966 and person_ID 967. Each row in the table Messages_people additionally includes an indication of the message field 968 of the email message in which the person's email address was included.

FIG. 9I illustrates the table News_items. Each row in the table News_items is uniquely identified by the values in the two fields user_ID 969, link 970, and GUID 971. A value in the field link is the link to the source of the new item extracted from an RSS document, and a GUID is a unique identifier of a news item assigned by the source web service. Additional fields in each row in the table News_items include: (1) title 972, the title of the new item; (2) description 973, the description of the news item; (3) date 974, the date/time that the news item was originally published; (4) read, shared, hide, spam, obscene, and off topic 975, six Boolean fields that indicate whether or not the news item was accessed by the user, shared by the user, hidden by the user, considered spam by the user, considered obscene by the user; and considered “off topic” by the user, respectively; (5) source 976, the web-service source of the new item; (6) entity_ID 977, a unique identifier of the company or person to which the new item is related; (7) entity_type 978, the type of entity, person, or company to which new item is related; (8) query 979, the search query used to obtain the news item; (9) created_at and updated_at, the date/time that the row was created and last modified, respectively 980; and (10) saved 981, an indication of whether or not the user wishes to save the news item.

FIG. 9J illustrates the table People. Each row in the table People is uniquely identified by a value in the p_ID field 982 or, alternatively, by the values in the pair of fields email 983 and user_ID 984. Additional fields in each row of the table People include: (1) name 985, the name of the person; (2) company ID 986, the company or organization with which the person is associated; (3) slider_importance 987, the user-defined importance or relevance of the person represented by the row; (4) news_last_fetch 988, date/time that news was last searched for the person identified by the row in the table People; (5) news_unread, news_read, news_saved, and news_off topic 989, the number of news items related to the person provided to, but not read by, a user or subscriber, the number of news items related to the person provided to, and read by, the user or subscriber, the number of news items related to the person saved by the user or subscriber, and the number of news items designated “off topic” by the user or subscriber, respectively; (6) news_watch 990, an indication of whether or not news should be searched for items related to this person; (7) news_include and news_exclude 991, which include terms that should occur in, or that should not occur in, news items related to this person, respectively; and (8) created_at and updated_at 992, the date/time that the row was created and last modified, respectively.

FIG. 9K illustrates the table Users. Each row, or entry, in the table Users represents an end user of the information-provision service. Each user is uniquely identified by a user ID contained in the user_ID field 993. The remaining fields in each row of the table Users contain additional information related to configuration of a user's interaction with the information-provision service and user-authentication information. For example, the remaining fields include the encrypted password of the user and the random value by which the password is encrypted, name and email address of the user, string values that allow a user to recover connection to the information-provision service when the user forgets the his or her password, values that specify a period of time over which importance of people and companies is computed by the information-provision service, and other such information.

The above-listed tables provide an enormous amount of information from which search queries can be constructed to search for information useful to, and needed by, users and subscribers of the information-provision service. In the above-described embodiment, the database is relatively flat, with tables containing rows for all users or subscribers of the information-provision service. In alternative embodiments, a separate set of tables may be created and managed for each user or for groups of users, so that the tables remain manageable and efficient sizes. The same information may be stored in a variety of different ways, using different tables, a different number of tables, and different types of entries for the different tables and different numbers of tables. The above tables are merely exemplary of the types of databases that may be constructed in order to generate search queries according to the various embodiments of the present invention. In addition, information gathered from users may be stored in formatted files, in other types of database management systems, and in additional types of data-storage facilities.

Relational database tables are easily created, modified, and searched. For example, SQL statements are provided, below, for (1) creating the above-described table Attendees, for (2) inserting a row into the table Attendees; for (3) finding the email addresses associated with a particular user identifier; and for (4) finding the email addresses associated with a particular user name:

| (1) | | |
|---|---|---|
| CREATE TABLE ATTENDEES | | |
| ( | EVENT_ID | INTEGER, |

| | |
|---|---|
| NAME | VARCHAR(100), |
| EMAIL | VARCHAR(80), |

| | |
|---|---|
| CREATED_AT | DATETIME, UPDATED_AT |

DATETIME);

| (2) | |
|---|---|
| INSERT INTO ATTENDEES | |
| VALUES | (6178, ‘Jerry Johnson’, ‘Jerry@jerry.com’, |

01/04/08-

12:13:16, 01/04/08-12:13:16);
(3)
SELECT EMAIL
FROM ACCOUNTS
WHERE USER_ID = 61344567;
(4)
SELECT ACCOUNTS.EMAIL
FROM ACCOUNTS, USERS
WHERE ACCOUNTS.USER_ID = USERS.USER_ID

AND USERS.NAME =‘Jerry Johnson’;

All of the statistics and inferences mentioned below can be obtained by using SQL queries to extract data from the above-mentioned relational tables and compute various values, and any of various programming languages can be used to write simple routines that compute more complex values from the extracted data values.

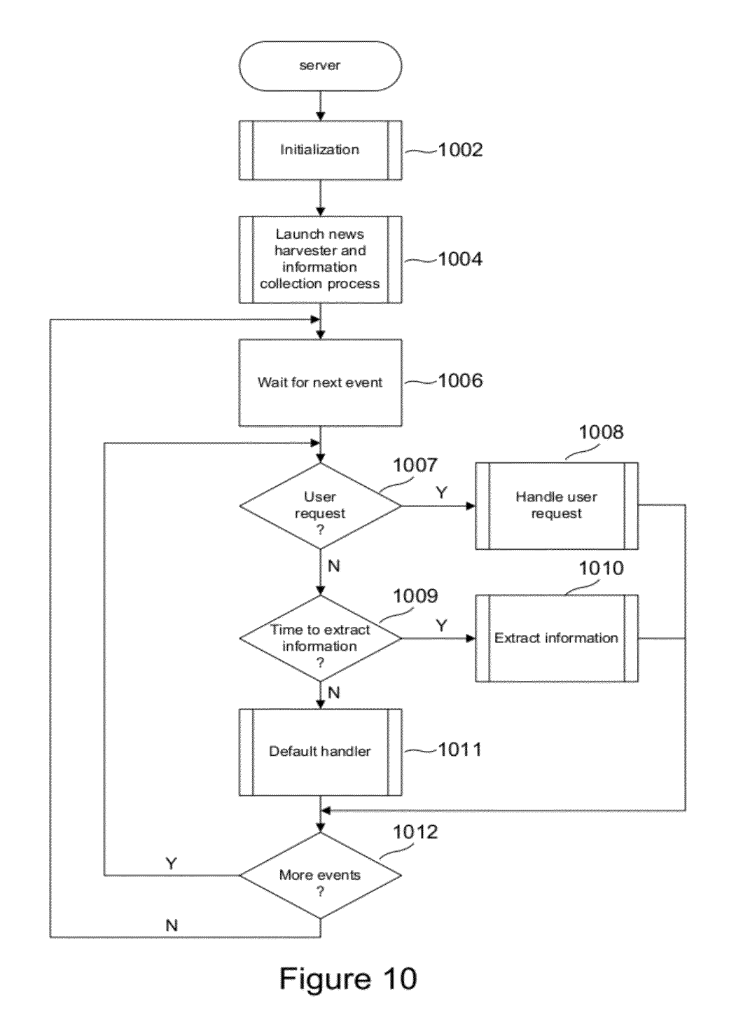

FIG. 10 provides a control-flow diagram that illustrates, at a high level, operation of the server of an information-provision service that represents one embodiment of the present invention. The term “server” may refer to a single computer system, may alternatively refer to a network of computer systems that receive requests for, and provide information to, users and subscribers, or may refer to a large, geographically distributed network of computer systems and mass-storage systems that together inter-cooperate to act as the server of an information-provision service. However the service system is implemented, the server of an information-provision service that represents one embodiment of the present invention generally carries out the steps shown in FIG. 10. In step 1002, an initialization process is carried out to create the database for storing information extracted from users and subscribers and configure the server to receive requests from users and potential users and respond to those requests. In one embodiment of the present invention, requests are received from users via the Internet, and the server provides information-containing web pages to the requesting users, in response. Other means for receiving requests and responding to requests are possible. Next, in step 1004, the server launches a news-harvesting process which periodically solicits information from RSS providers and processes information received from the RSS providers and an information-collector process that receives bundles of email-message descriptions of calendar-event descriptions transmitted from extractor executables running on users' computers. Then, in a continuous loop comprising steps 1006-1012, the server continuously waits for events, in step 1006, and handles events that occur. If a user request is received, as determined in step 1007, then the request is handled in step 1008. If a timer event occurs to signal that information needs to be again extracted from one or more users, as determined in step 1009, then information is extracted from the 4ser or users in step 1010. Other events are handled by a default handler 1011. By continuously or periodically extracting information from users and handling user requests, the information-provision service continuously or periodically supplies information to the users of, or subscribers to, the information-provision service. In alternative embodiments, information provision may occur automatically, at specified or inferred intervals, in addition to being provided on demand, as shown in FIG. 10. In alternative embodiments, searches for information useful to, and needed by, users and subscribers may occur at specified or inferred intervals, independent of, or in parallel with, handling of requests for information. Many different alternative models are possible.

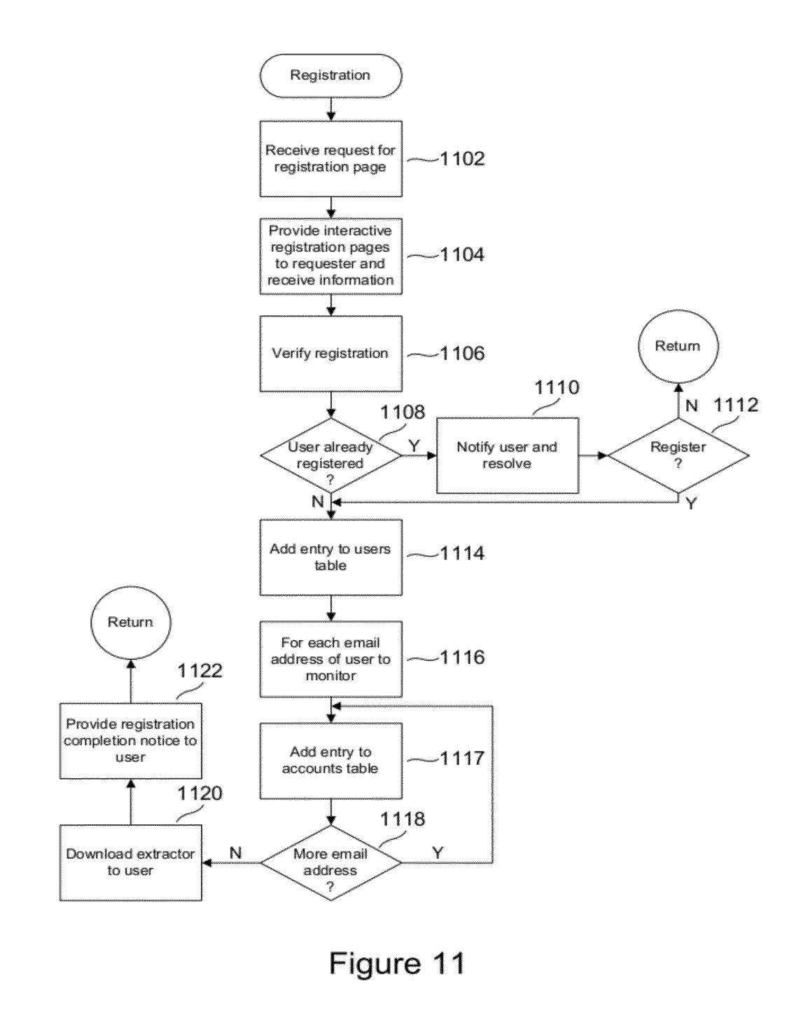

One type of user request is a request from a potential user to subscribe to, or register with, the information-provision service. FIG. 11 provides a control-flow diagram for the registration process, as carried out by an information-provision-service server that represents one embodiment of the present invention. In step 1102, the information service receives a request from a potential user or subscriber for the initial registration page via the Internet. In step 1104, the information-provision service responds to the request by undertaking a web-page-based dialog with the requesting user, during which information is collected from the user. In step 1106, the information-provision service verifies, when possible, information received from the requesting potential user or subscriber. For example, an information-provision service may communicate via email with the prospective user or subscriber, in order to verify the prospective user's or subscriber's email addresses. As another example, when the information-provision service provides information on a fee basis, the information-provision service may verify credit cards, debit accounts, or other means by which the user or subscriber elects to pay for the service. In step 1108, the information-provision service determines whether the prospective user is already registered with the information-provision service, by accessing the Users table and Accounts tables, described above. If the user has already registered, then, in step 1110, the user is notified and an additional dialog ensues, following which the information-provision service determines whether or not to proceed with registration, in step 1112. In order to register a prospective user or subscriber, the information-provision service prepares and adds an entry to the Users table, in step 1114, and then, for each email address of the user that is to be monitored by the information-provision service, an entry is prepared and entered into the Accounts table in the for-loop of steps 1116-1118. In step 1120, an extractor executable is downloaded by the information-provision service to the user's computer. The extractor may either periodically awaken, and upload email messages, calendar events, and other information from the user's computer to the information-provision service, or, alternatively, may be awakened by the information-provision service at determined times in order to upload information from the user's computer. Finally, in step 1122, information-provision service provides notice of successful registration and any other, additional information needed by the user or subscriber. Again, as with the control-flow diagram provided by FIG. 10, and as with control-flow diagrams addressed below, many different alternative embodiments are possible. In any actual system, much additional logic may be included in the registration process in order to handle various errors, low-probability complexities that may arise during the registration process, and the collection and storage of additional types of information needed by the information-provision service.

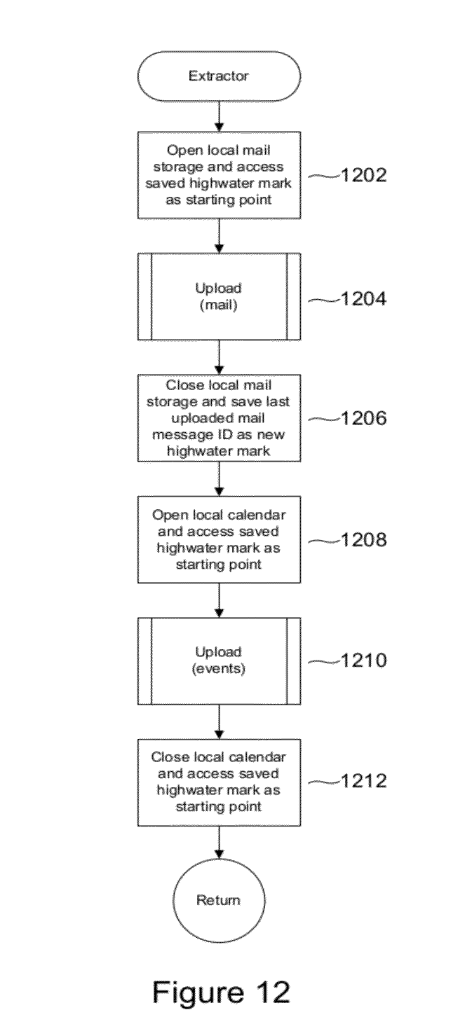

FIG. 12 provides a control-flow diagram for an extractor executable downloaded by the information-provision service to the computer of a user of, or subscriber to, an information-provision service that represents one embodiment of the present invention. As discussed above, the extractor may, in certain embodiments, run as a process on the user's computer, and reawaken periodically to extract information from the user's computer, or from computers accessible from the user's computer, for upload to the information-provision service or, in alternative embodiments, may be explicitly invoked by the information-provision-service server in order to extract information from the user's computer, or from computers accessible from the user's computer. When invoked, the extractor, in step 1202, opens the mail-storage facility on the user's computer, or on a computer accessible from the user's computer, and accesses any saved email messages that follow, in time, a saved high-water mark, or reception time, of the last email message previously extracted by the extractor. Of course, in the case of a first access of the extractor to the mail-storage facility, the extractor may process all stored emailed messages, or all email messages that were received during some preceding, predetermined interval. In one embodiment, the extractor runs as a COM add-in in the Microsoft Outlook program and extracts email messages stored in .pst files using an Outlook API. However, the extractor can be implemented to extract email messages from any of numerous different types of local email programs and email-message-storage facilities. The extractor may locally store necessary passwords and authentication information for accessing the local email storage, or, alternatively, may obtain that information from the information-provision service. In step 1204, the extractor uploads portions of the saved email messages. In step 1206, the extractor closes the local email-message storage facility and saves the time of reception of the last email message extracted, so that, in a subsequent execution, the extractor can begin with the next email message received by the user or subscriber. High-water marks, either message IDs or the date/time for a last-processed message, may be stored locally by the extractor or stored by the information-provision service. In steps 1208, 1210, and 1212, the extractor similarly opens the user's local calendar application and uploads information regarding events stored in an event-storage facility that either resides on the user's computer or resides on a remote computer accessible from the user's computer.

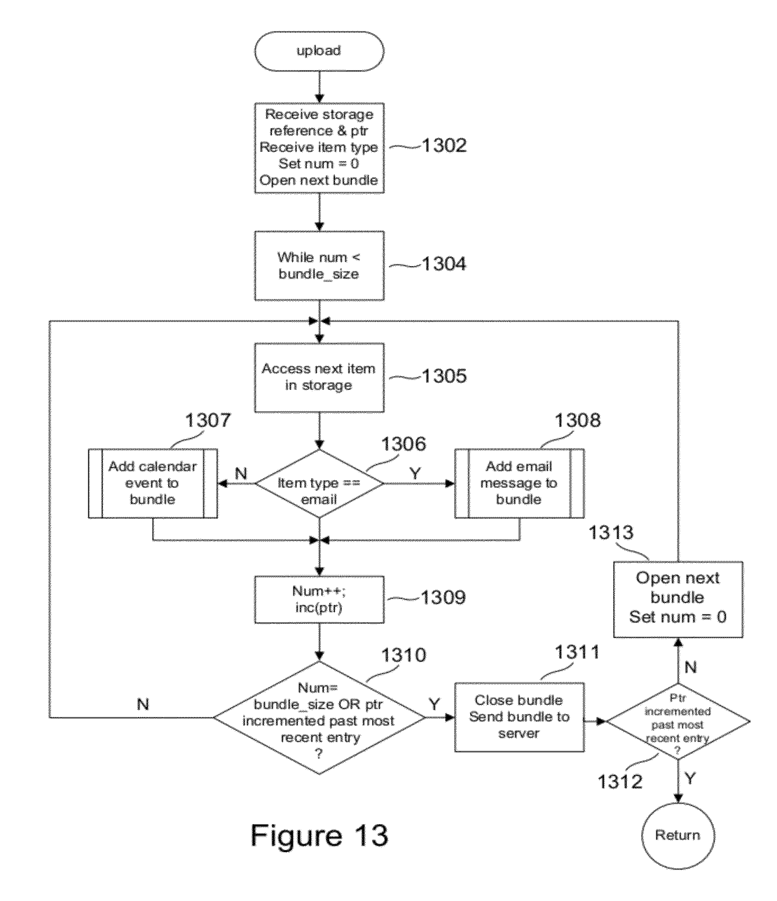

FIG. 13 provides a control-flow diagram for the routine “upload,” called in steps 1204 and 1210 of FIG. 12. In step 1302, a reference to the storage facility in which information is to be uploaded, a pointer to a first entry in the storage facility to begin uploading from, and an item type are received. The local variable “num” is set to zero, and the next bundle is opened, into which information extracted from the storage facility is placed. In one embodiment of the present invention, a bundle is simply an XML file. In the while-loop of steps 1304-1313, information extracted from the storage facility, such as a calendar-event storage file or email-message storage file, is placed into successive bundles and transmitted to the information-provision service. In step 1305, the next item in the storage facility is accessed. If the type of item is an email message, as determined in step 1306, then, in step 1308, a routine is called to add information extracted from the email message to the current bundle. Otherwise, a routine is called in step 1307 to add information extracted from a calendar event to the bundle. In step 1309, the local variable “num” is incremented, and the pointer to entry in the information-storage facility is also incremented to a next, more recently received or created entry. When the bundle is full, or there are no more entries in the storage facility, as determined in step 1310, then the bundle is closed and transmitted to the information-provision service, in step 1311. If there are more entries in the storage facility to process, as determined in step 1312, then a new bundle is opened and the local variable “num” is set to zero, in step 1313, before control flows back to step 1305. Otherwise, the routine “upload” ends.

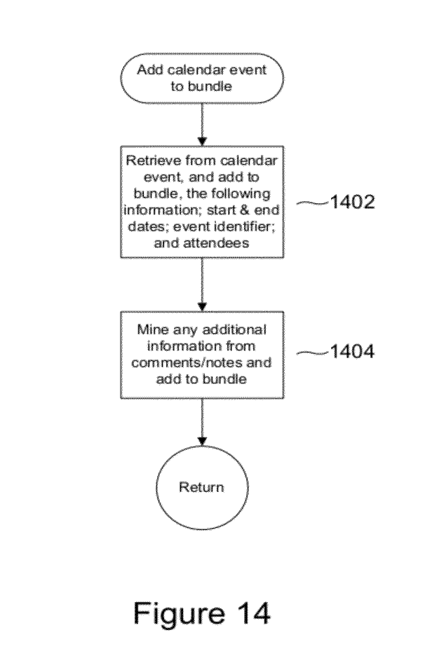

FIG. 14 provides a control-flow diagram for the routine “add calendar event to bundle,” called in step 1307 of FIG. 13. In step 1402, the start and end date times, event identifier, and a list of attendees is extracted from a calendar event and added to the currently opened bundle after formatting so that information is properly interpreted by the subsequently receiving information-provision service. In step 1404, any additional information, such as links included in comments and notes within the calendar event, names parsed from the comments and notes, and other such information, may be additionally included in the bundle.

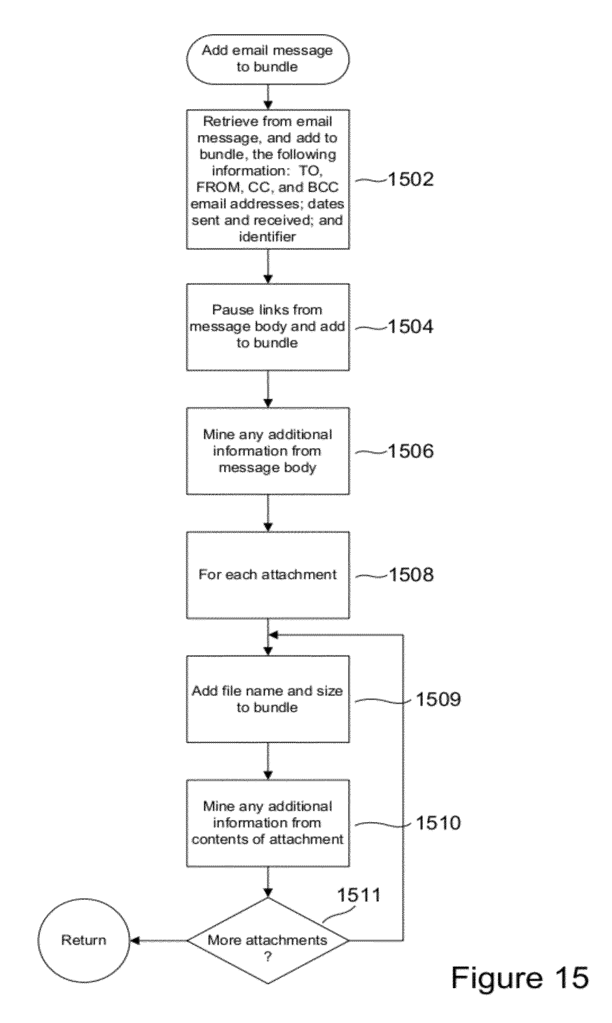

FIG. 15 provides a control-flow diagram for the routine “add email message to bundle,” called in step 1308 in FIG. 13. In step 1502, various fields of the email message, described above with reference to FIG. 8A, are extracted. In step 1504, links are parsed from the message body of the email message and added to the bundle. In step 1506, any additional information that can be mined from the message body is mined from the message body and placed into the bundle. Finally, in the for-loop of steps 1508-1511, the file name and size of each attachment associated with the email message is added to the bundle, along with any additional information that can be mined from attachments.

Again, the control-flow diagrams of FIGS. 12-15 are intended to illustrate a general, exemplary embodiment of the extractor. Particular extractors may contain additional logic for extracting and bundling particular types of information from particular types of information sources, in addition to email messages and calendar events. Thus extractors may be specifically implemented for various different types of information sources and information-storage facilities.

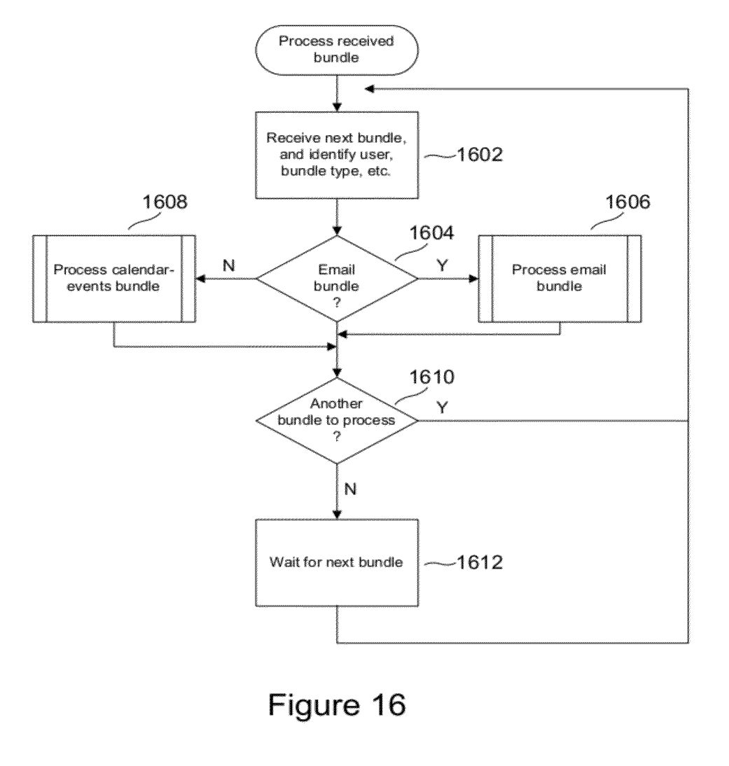

FIGS. 16-18 provide control-flow diagrams for reception and processing of extractor-transmitted information bundles by the information-provision service. As shown in FIG. 16, an information-provision-service process continuously waits for the arrival of new bundles and user extractors. When the next bundle is received, the process, in step 1602, identifies the user from which the information was received, type of bundle, and other such information to allow the process to process the bundle. If the bundle contains email messages, as determined in step 1604, then a routine for processing email bundles is called, in step 1606. Otherwise, a routine for processing calendar events is called, in step 1608. When there is another bundle queued for processing, as determined in step 1610, then control flows back to step 1602. Otherwise, the process waits, in step 1612, for the next bundle to be received before control flows back to 1602. In certain embodiments, the information-provision service may launch a single process for receiving information bundles from extracted executables running on user's computers. In alternative embodiments, a number of processes may run at the information-provision service, each process receiving bundles on particular communications ports. Many different implementations are possible, depending on configuration of the information-provision-service servers and service facilities, the number of users and subscribers, and other such parameters.

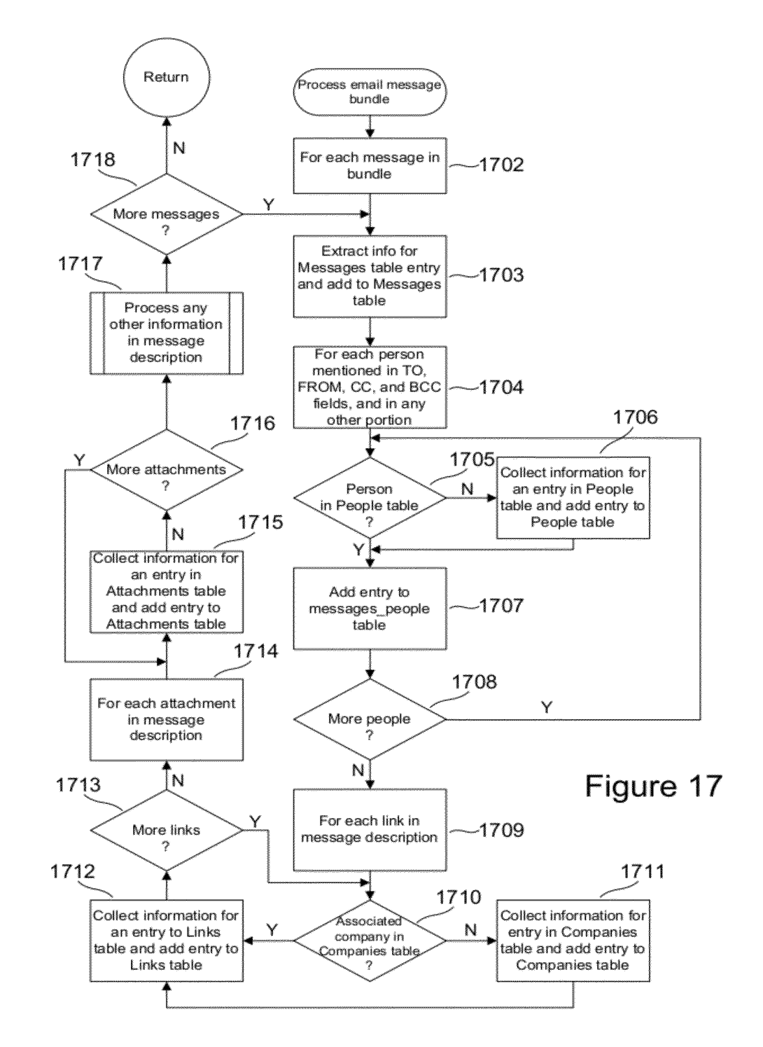

FIG. 17 illustrates the routine “processEmailMessageBundle” called in step 1606 of FIG. 16. In the for-loop of step 1702-1718, all of the information related to each message in the bundle is processed for each message in the bundle. In step 1703, information is extracted from the current message being processed in the bundle to create an entry and add the entry to the messages table. In the for-loop of steps 1704-1708, each person whose email occurs in any of the to, from, cc, and bcc fields of the email message is extracted. If an entry for the person is not found in the People table, as determined in step 1705, then information is collected from the bundle and from any other sources of information available to the information-provision service in order to create an entry, or row, in the People table corresponding to the person, in step 1706. In step 1707, an entry corresponding to the person is entered into the Messages_people table. In the for-loop of steps 1709-1713, each link included in the description of the email message is processed in order to add an entry, for each link, to the Links table in step 1712. If the company organization associated with the link has no entry in the Companies table, as determined in step 1710, information is collected in order to prepare and add an entry to the Companies table, in step 1711. In the for-loop of steps 1714-1716, information in the representation of the message concerning attachments is processed in order to add an entry into the Attachments table for each attachment associated with the email message. In step 1717, any other information available in the description of the email message currently being processed is extracted and used to prepare additional entrees for additional database tables or to modify fields in existing database-table entries.

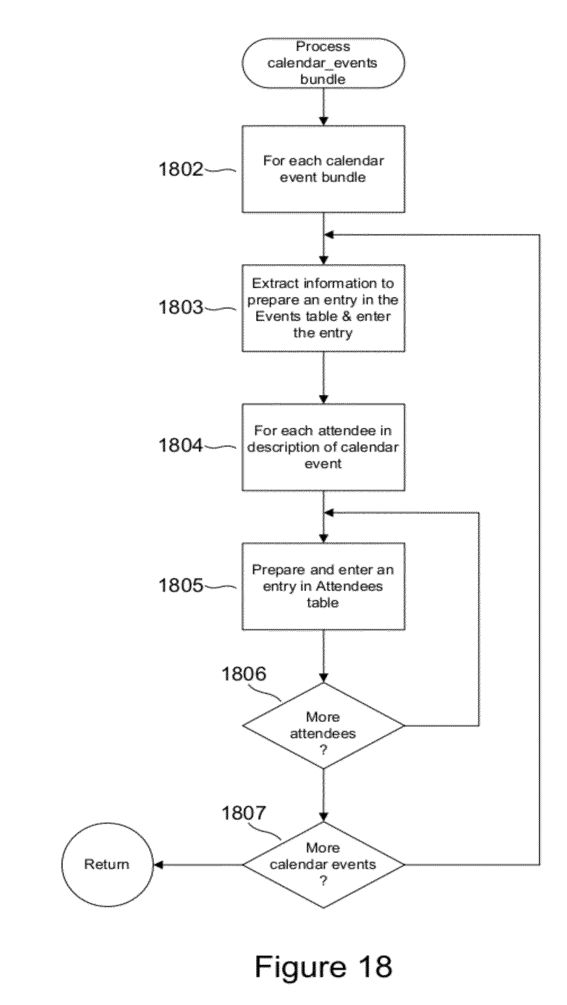

FIG. 18 provides a control-flow diagram for the processing of calendar events in a calendar-event bundle, called in step 1608 of FIG. 16. In the for-loop of steps 1802-1807, each representation of a calendar event is processed. Information is extracted from a currently processed event, in step 1803, to prepare an entry for the Events table. Then, in the for-loop of steps 1804-1806, each attendee associated with the event is processed, and an entry is prepared and entered into the Attendees Table for each attendee.

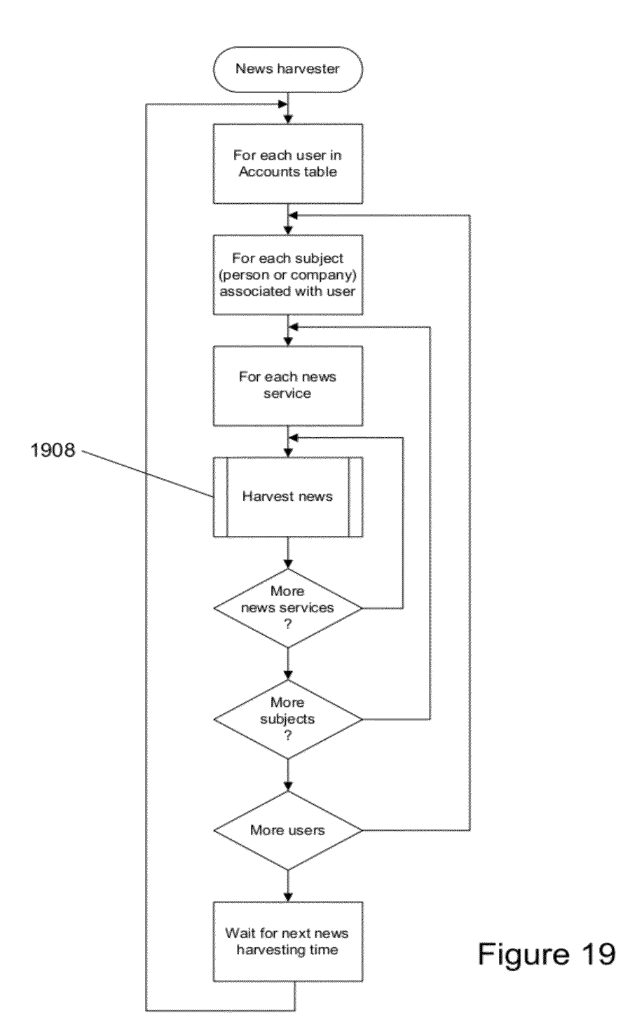

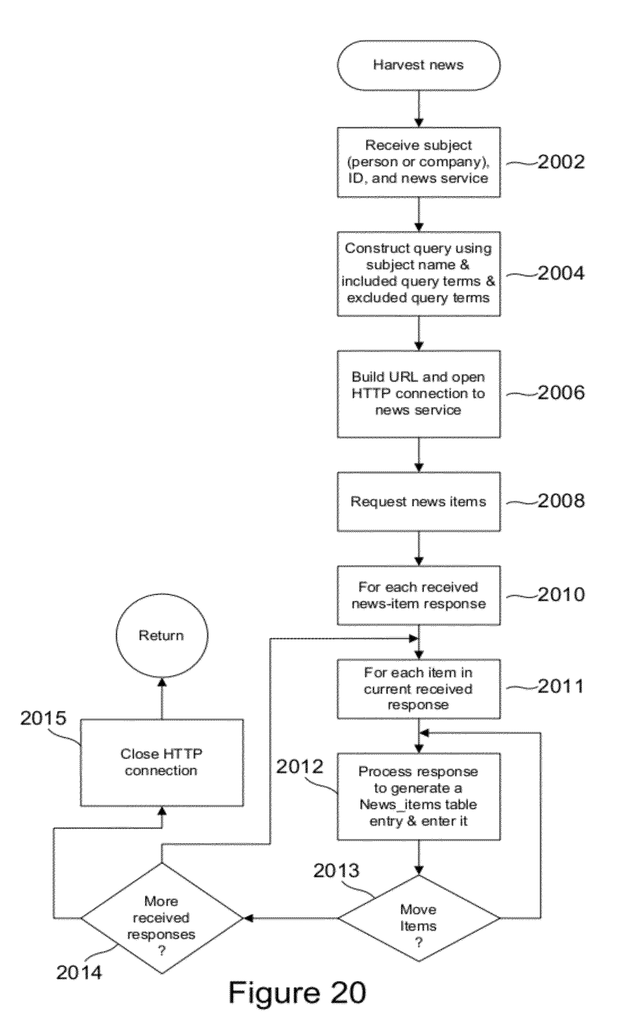

FIGS. 19-20 provide control-flow diagrams for the news-harvester process that runs on the information-provision-service server. In the embodiment shown in FIG. 19, at each point in time when the news harvesting process is launched or invoked, the news harvester harvests news from RSS sources, and other information sources, for each subject important to, or relevant to, each user. In alternative embodiments, the news harvester may be separately invoked for each user, or for groups of users, so that news harvesting is carried out in a more continuous and balanced fashion. News is harvested from a particular news service for a particular subject, person, or company, for a particular user via a call to the harvest news routine in step 1908 of FIG. 19. In certain embodiments, news requests for news related to multiple subjects and users may be coalesced, and the obtained news items then distributed to users and/or stored on behalf of users.

FIG. 20 provides a control-flow diagram for the routine “harvest news” called in step 1908 of FIG. 19. In step 2002, the routine “harvest news” returns an identifier for the subject (person or company) in reference to the news service from which information is to be harvested. In step 2004, the routine “harvest news” constructs a query for soliciting news using the name of the subject, excluded and included query terms, and other relevant information obtained from an entry corresponding to the subject in the People or Companies table. In step 2006, a URL is constructed to open an HTTP connection to the news service and, in step 2008, the URL is employed to request news items from the news service. For each XML message received from the news service in response to the query, in the for-loop of steps 2010-2014, each entry in the news item is processed, in the for-loop of steps 2011-2013, in order to extract information to prepare an entry for the News_items Table and enter the entry into the News_items Table. Then, in step 2015, the HTTP connection is closed.

Thus, the above-described control-flow diagrams and data tables illustrate one embodiment of the present invention, in which an information-provision service continuously extracts information from users' and subscribers' computers, and computers accessible from those computers, in order to maintain a database of information from which queries can be generated for searching a wide range of information sources, including the world-wide web, in order to obtain information related to companies and people important to, or relevant to, individual users and subscribers. In one embodiment of the present invention, the information obtained using the generated queries is provided on demand to users and subscribers via web pages generated dynamically on request by users and subscribers. These web pages, and the types of information provided to users and subscribers of the information-provision service that represents one embodiment of the present invention, are next described.

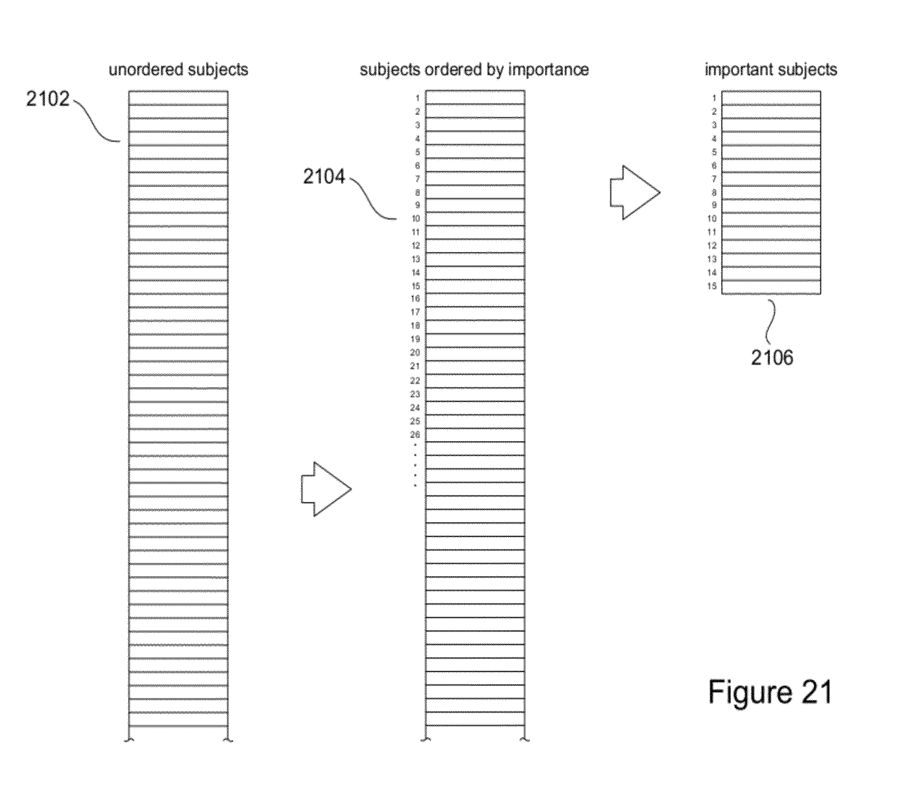

One important type of derived information maintained by the information-provision service that represents one embodiment of the present invention is a relevance or importance rank associated with each subject, for each user or subscriber, about which information is continuously sought, on behalf of the user or subscriber, by the information-provision service. The information-provision service, at a conceptual level, continuously calculates the importance and relevance of subjects, for each user and subscriber, so that the subjects of highest importance or relevance are used to generate search queries for searching the Internet and other information sources. Otherwise, were information sought for all subjects, the information-provision service might well be overwhelmed with generating search requests and processing responses from those requests, and users and subscribers would end up sifting through enormous amounts of essentially irrelevant or unimportant information returned by the information-provision service. FIG. 21 illustrates the importance or relevance ranking computed by the information-provision service. For each different type of subject, in one embodiment including people and companies, the complete list of subjects maintained in the database for a particular user or subscriber 2102 is reordered by an importance or relevance ranking computed for each subject to produce an importance or relevance ordered subject list 2104. Those subjects with highest importance or relevance are then used as the set of important objects 2106 for the user, from which search queries are generated for searching the Internet and other information sources in many cases, many more than the 15 most important subjects are used for searching the Internet and other information sources, and the returned information is then ranked for relevance and importance, and only the highest-ranked information items are provided to a user, or initially provided to a user. Thus importance and relevance ranking may be carried out at multiple levels on behalf of a given user.

In one embodiment of the present invention, the initial computed importance for a person is a ratio comprising the number of email messages sent by a user to the person divided by the number of email messages received by the user from the person, the ratio then multiplied by the total number of email messages extracted from the user's email accounts to which the person is related. In one embodiment of the present invention, the initial computed importance for a company is the average importance rank for people important to the user who are associated with the company. In both cases, the computed importance may be normalized and scaled to a convenient integer range. Many other computed importance metrics are possible, including importance metrics that take into account more, or all, of the person-related and company-related data stored in the above-described database.

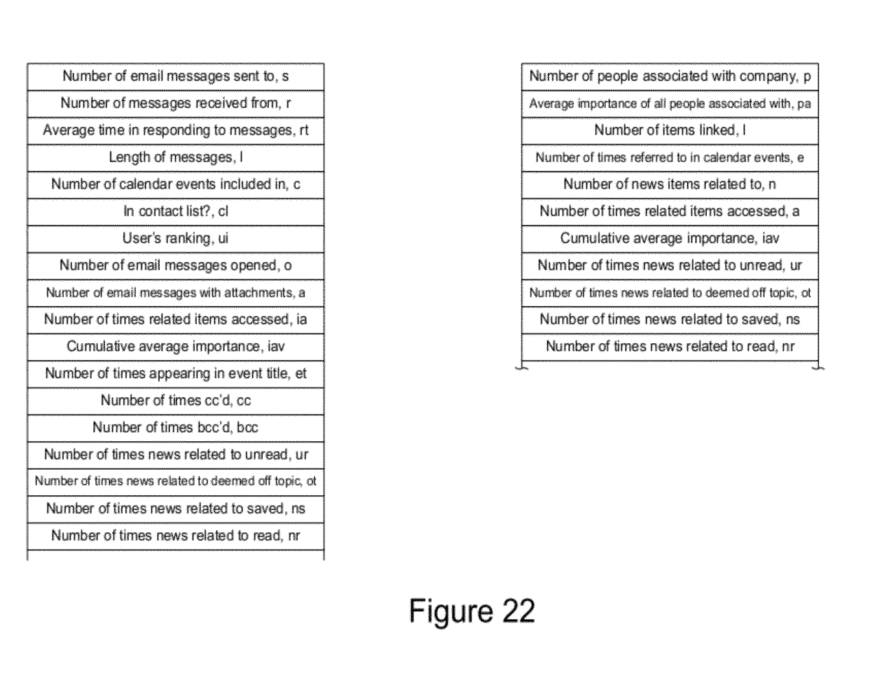

The database described above with reference to FIGS. 9A-K, includes a wealth of information from which importance or relevance can be computed. FIG. 22 shows various types of information stored in, or that can be inferred from, data stored in the above-described database used to compute relevance or importance. For example, for people 2202, values that can be factored into a computation of relevance or importance include the number of email messages sent to the person, the number of email messages received from the person, the average time that the user took to respond to email messages from the person, the length of the email messages received from the person, the number of calendar events which the person is included in, as an attendee, whether or not the person is in the user's contact list, the user's ranking of the person, the number of email messages from the person actually opened by the user, the number of email messages received from the user with attachments, the number of times items related to email messages from the per on were accessed, the cumulative average importance computed for the person over some preceding period of time, the number of times the person's name appears in an event title, the number of times the person's email address appears in various email-message fields, including to, from, cc, and bcc, the number of times these items related to the person that were read, the number of times these items related to the person were read, the number of times these items related to the person were deemed off topic by the user, and the number of times these items related to the person were saved by the user. This is, of course, an incomplete list of potential considerations and factors for computing the relevance or importance for a person. Similarly, a list 2204 of factors that may be taken into consideration when computing the importance or relevance of companies is shown in FIG. 22. These factors include the number of people associated with the company that are important or relevant to a user, the average importance, to the user, of all people associated with the company, the number of times a company was linked in email messages received or sent by the user, the number of times a company was referred to in calendar events, the number of news items related to the company, the number of times items related to email messages containing the company were accessed, a cumulative average importance or relevance of the company computed over some past interval of time, the number of times news items related to the company were accessed, the number of times news items related to the company were deemed off topic, the number of times news items related to the company were saved by the user, and the number of times news items related to the company were read by the user. Again, this is only a sample of the many various different stored and computable values that may be taken into account when computing relevance or importance.

On a fixed interval, or on demand from users and subscribers, the information-provision service that represents one embodiment of the present invention recomputes the importance, or relevance, of each subject identified for the user, including people and companies, and search queries are then prepared for the most highly ranked companies and people to enable the information-provision service to gather information from the Internet and other such sources to then provide to the user or subscriber. In large information-provision-service computing centers, ongoing searching of the Internet and other information sources may be carried out on behalf of all users and subscribers, so that, when requested by a user subscriber, the information-provision service can quickly search indexed lists of already obtained information in order to provide the information on demand. In other cases, a search of the Internet and other information sources may be performed in response to a request for information by the user. In certain cases, information provided to the user may be provided on a continuous basis, in an automated fashion. However, in one embodiment of the present invention, information is provided to a user through a web-page-based dialog.

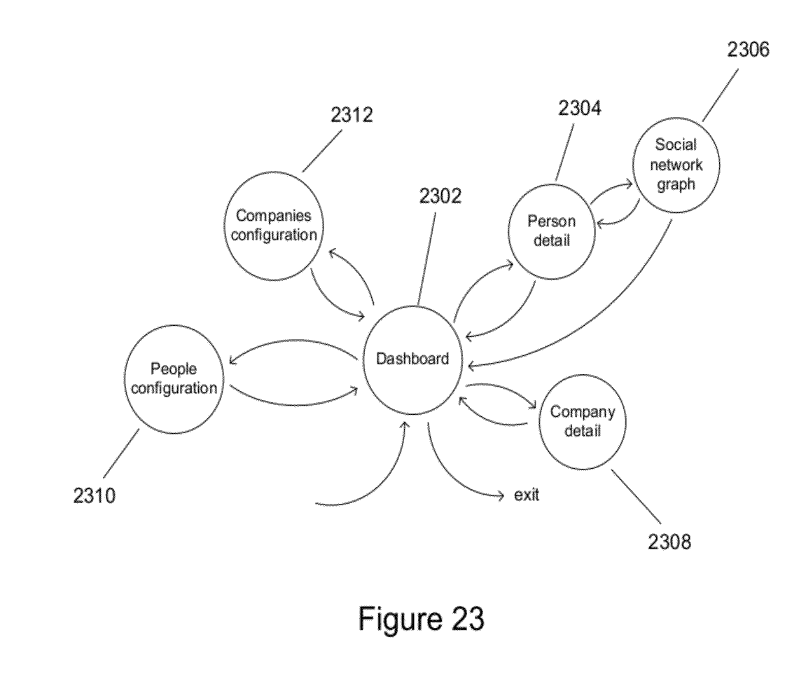

FIG. 23 shows a state-transition diagram that illustrates the web pages provided to a user by an information-provision service and the various ways in which a user navigates through the web pages in order to obtain important and relevant information from, and provide feedback to, the information-provision service, according to one embodiment of the present invention. Initially, when the user requests information from the information-provision service, the information-provision service provides a dashboard page 2302 which summarizes the most important and relevant information currently available for the user. A user may select additional, detailed information about any of the important and relevant subjects displayed on the dashboard page. For example, a mouse click or other input to a dashboard-page entry describing information related to a particular person may then result in display to the user of a person-detail page 2304 further describing that person. In addition to the person-detail page, a social network graph related to the selected person may be displayed 2306. Similarly, a company-detail page may be requested via input to a company displayed on the dashboard 2308. From the dashboard, a user may request a people-configuration page 2310 or a company's-configuration page 2312 that allows a user to modify the importance of companies and people, delete companies and people, add companies and people, and otherwise modify the contents of the database related to the user maintained by the information-provision service. Of course, the state-transition diagram shown in FIG. 23 is but one of an essentially limitless number of different possible web-page-based dialogs by which information can be distributed to a user or subscriber by the information-provision service. Additional types of information-containing pages may be selected and displayed, the contents of any of the pages may differ in different embodiments, and the methods by which the pages are created and information selected for the pages may differ in different embodiments.

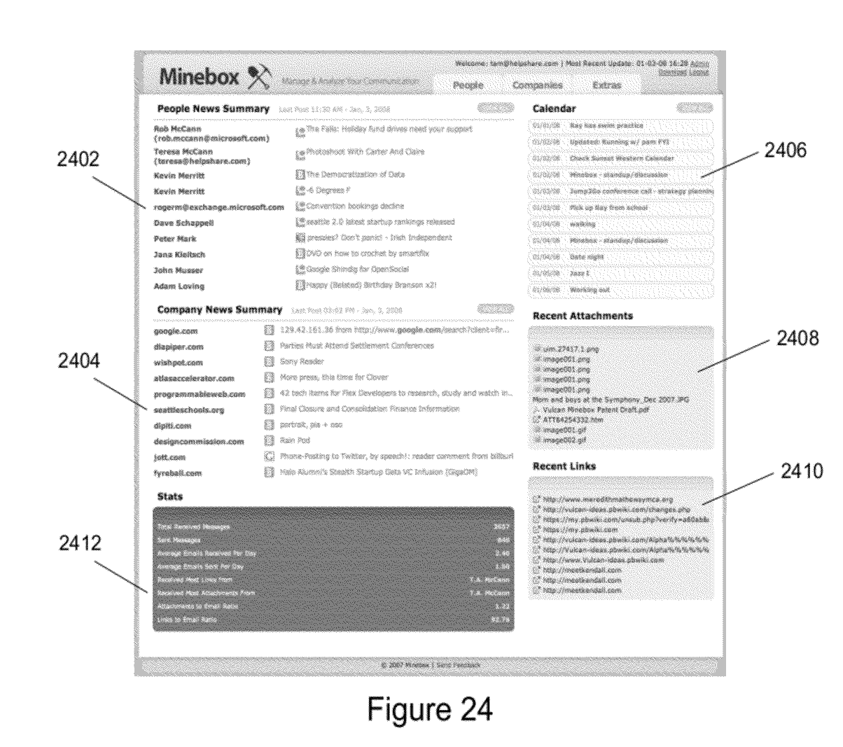

Next, examples of the various types of information-displaying web pages provided to a user or subscriber by one embodiment of an information-provision service are discussed. FIG. 24 shows a screen capture of a dashboard page, the central web page of the web-page-based dialog discussed with reference to FIG. 23 and the initial web page displayed to a user who requests information, according to one embodiment of the present invention. The dashboard displays a list of current information items related to selected important and relevant people 2402, current news items related to selected important and relevant companies 2404, a list of calendar events representing upcoming, scheduled events 2406, a list of attachments recently received in emails 2408, a list of links recently received in email-message bodies 2410, and a list of statistics computed based on uploaded email messages and calendar events 2412. Thus, the dashboard provides a user or subscriber, in one page, a brief and easily read and understood summary of the most relevant current information about certain of the people and companies most relevant and important to the user, as well as additional information and statistics related to email traffic and the user's calendar. A mouse click input to any of the listed attachments, links, calendar events, people, and companies may then invoke display of the attachments, linked web pages, calendar items, and detail pages for people and companies.

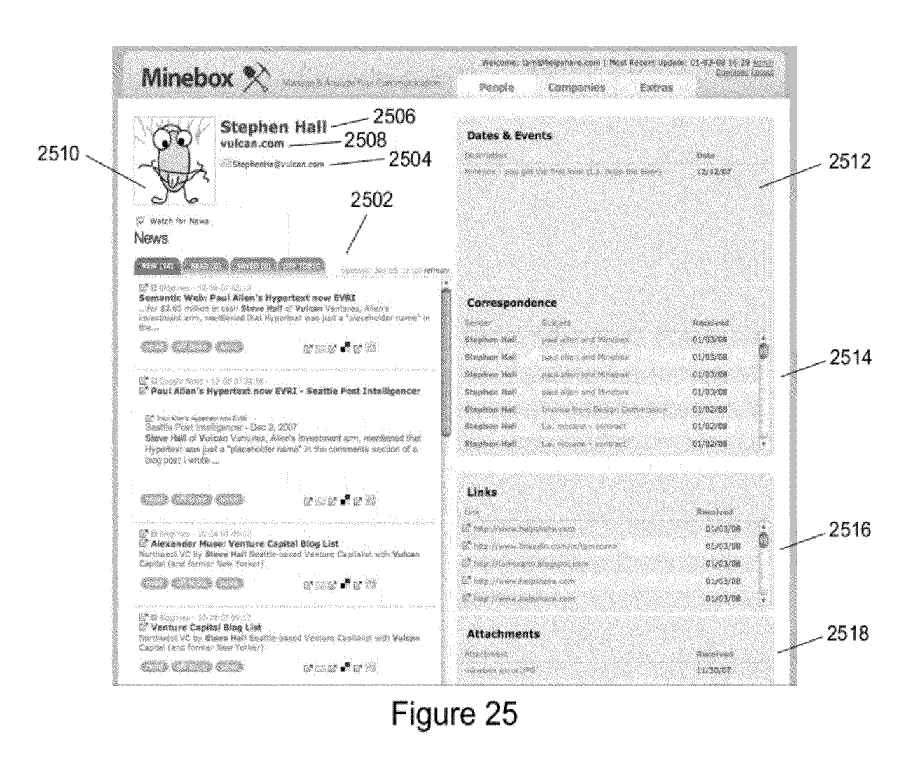

FIG. 25 shows a person-detail page that may be displayed to a user when the user inputs a mouse click to a person listed on the dashboard page, or in response to a specific request by a user for information about the person, according to one embodiment of the present invention. The page lists recent information items, including RSS news feeds, related to the person 2502, the person's email address 2504, name 2506, and organization 2508, a picture of the person 2510, when available, calendar events related to the person 2512, recent correspondence with the person 2514, links containing email messages received from the person 2516, and attachments recently included in the email messages received from the person 2518.

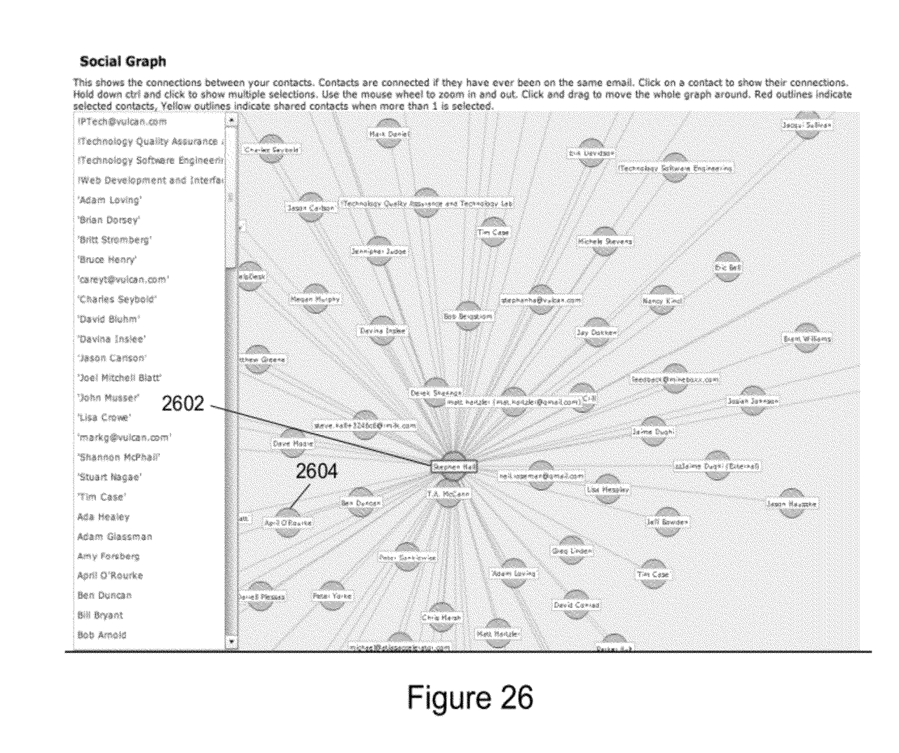

FIG. 26 illustrates a social graph for a person provided by the information-provision service according to one embodiment of the present invention. The social graph is computed for all other people associated with the user with respect to a particular person associated with the user. An icon representing the particular person associated with the user 2602 occurs at the center, or hub, of the graph. Accounts for all other people associated with the user are positioned relative to the particular person, to indicate the social-network distance of each of the other people with respect to the particular person. For example, given that T. A. McCann is the user for which the social graph is provided, and given that Stephen Hall is the subject of the social graph, then the distance between the icon representing April O'Rourke 2604 and the icon representing Stephen Hall 2602 is reflective of, for example, the number of emails or calendar events that include T. A. McCann, Stephen Hall, and April O'Rourke. Many other ways of computing social-network distances can be used. In certain cases, multiple icons, representing multiple persons important or relevant to a user, can appear at the hub or center of the social graph, so the social graph represents a social-network distance between all other people and the two people at the center of the social-network graph. There are many other possible ways of computing social-network affinities or distances, and many other possible ways for representing and displaying social-network graphs. However, in all cases, the intent is to graphically display relationships among the user and people important and relevant to the user.

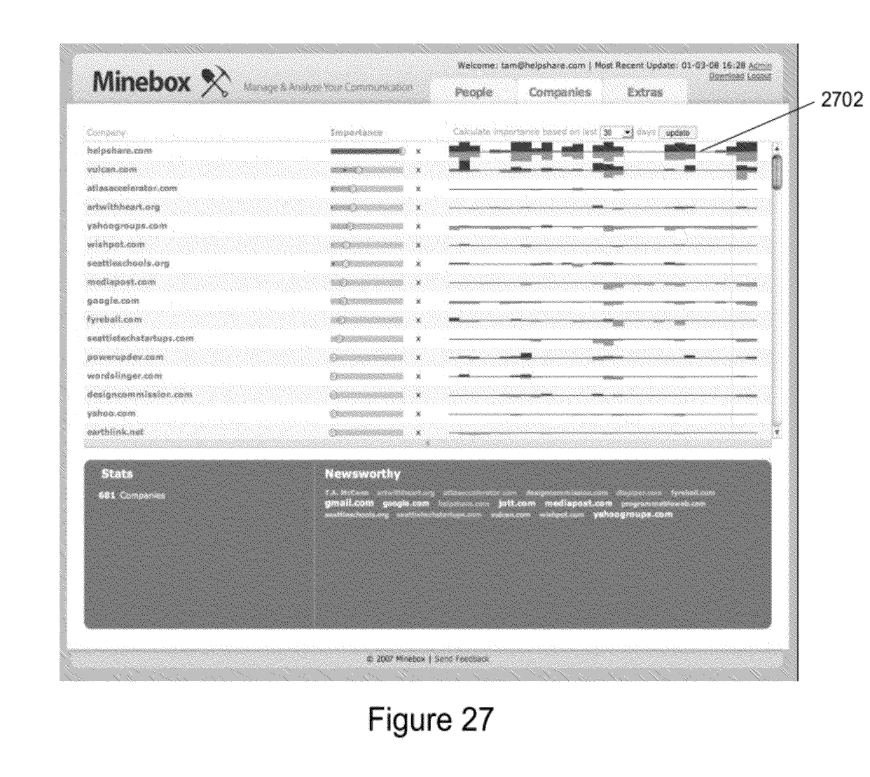

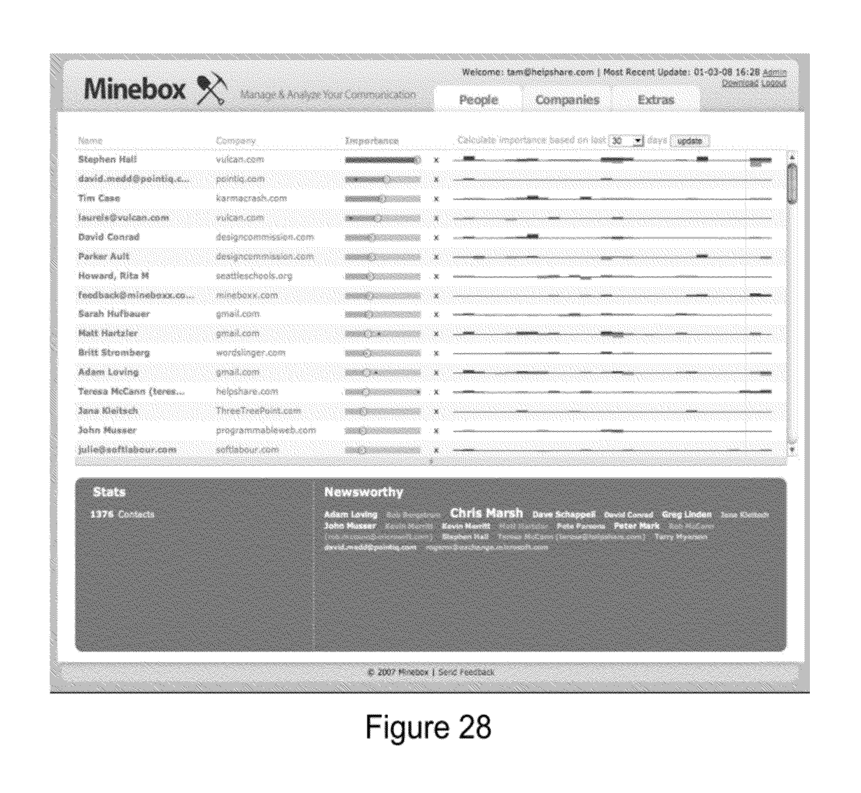

FIGS. 27 and 28 shows a company-configuration page and a person-configuration page, respectively, according to one embodiment of the present invention. These pages provide lists of people and companies, a graphical representation of the current importance or relevance computed for the people or companies, the sliding-scale input feature, such as sliding-scale input feature 2702 in FIG. 27, that allows a user to adjust the importance or relevance associated with a particular person or company, as well as to adjust the period of time for which statistics computed from data collected by the information-provision service are used in order to assign an importance or relevance to a person or company.

Searches for information related to companies, people, and other subjects of interest are performed using automatically generated queries. The queries are generated from the information stored in the database created and maintained by the information-provision service to store information collected from users' computers, collected from computers accessible from the users' computers, collected directly from users through web-base-based dialogues, and collected from various additional information sources. Searches may be carried out iteratively, with an initial query refined to enable a better focused, subsequent search. Search queries may be iteratively modified according to the amount and nature of information returned in a preceding search. An Internet-directed search query resulting in too many related web pages, for example, may be modified to include more terms, or more precise terms, in order to produce a more manageable amount of returned information. Conversely, a search query producing too little information may be broadened or expanded to produce a greater amount of information in a subsequent search. Search queries may also be modified by user feedback, by trends and results collected over the course of a number of searches undertaken for a particular user, group of users, or all users. Search terms may additionally be gleaned from previously obtained information from previous searches.

The described embodiment of the present invention is a convenience, accessible, and extremely useful companion to commonly available email applications, such as Microsoft Outlook, and electronic calendars, such as the calendar provided by Microsoft Windows operating systems. Information provided by an information-provision service that represents an embodiment of the present invention includes information obtained from stored email messages and calendar events, but also includes information obtained by searching a variety of information sources, including the Internet and RSS feeds, for information related to those people and companies that are relevant and important to a particular user. The provided information would be otherwise obtainable by a user or a subscriber of the information-provision service only through tedious and extremely time-consuming searching via web browsers and other applications. For example, salesmen, corporate executives, advertising executives, managers of political campaigns, and many other people who depend on electronic communications with large numbers of people on a daily basis can easily obtain current updates of those people by accessing the dashboard page and a few, additional selected person-detail and company-detail pages.

Although the present invention has been described in terms of particular embodiments, it is not intended that the invention be limited to these embodiments. Modifications within the spirit of the invention will be apparent to those skilled in the art. For example, an almost limitless number of different information-service-provision implementations can be crafted using different programming languages, operating system platforms, hardware platforms, modular organizations, control structures, data structures, database-management systems, and by varying other common programming and development parameters. Although the above-described embodiment focused on people and companies that are relevant and important to users, any number of additional or different types of subject matter can be tracked by an information-provision service on behalf of users and subscribers. As discussed above, information can be extracted automatically from users' computers, and computers accessible from users' computers, on behalf of users and subscribers in order to maintain efficient information about users and subscribers to determine the relative importance and relevance of various subjects, including people and companies, and crafting search queries by which information can be obtained from a variety of sources relative to the people and companies of importance and relevance to a user. Information may be provided automatically, or on request from users and subscribers. Any number of different display methods and information-request strategies and paradigms may be employed.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1.-24. (canceled)

25. An information-provisioning server comprising:
a data-storage component that receives and stores information extracted from at least one of a user computer and computers accessible from the user computer, the extracted information extracted from applications at the at least one of the user computer and the computers;
an information-search component that
retrieves from the data-storage component at least part of the extracted information, to order information subjects with respect to importance of a person, and
searches for information related to a number of the information subjects having highest importance, provided by web servers and RSS feeds over the Internet, and from other electronic-information systems accessible to the information-search component; and
an information-provision component that provides at least part of the searched information obtained from the information-search component to the user computer.

26. The information-provisioning system of claim 25 wherein the importance for a person comprises an initial value further comprising the number of emails sent by the user to the person divided by the number of email messages received by the user from the person, then multiplied by the total number of email messages extracted from one or more user's email accounts to which the person is related.

27. The information-provisioning system of claim 26 wherein the information-search component recomputes the importance for information subjects on a fixed interval or on demand by the user.

28. The information-provisioning system of claim 25 wherein the searching for information related to information subjects having highest importance is ongoing.

29. The information-provisioning system of claim 28 wherein the information-provision component that provides at least part of the searched information obtained from the information-search component to the user computer is on a continuous basis or in response to receiving a request from the user computer.

30. The information-provisioning system of claim 25 wherein the data-extraction component extracts representations of email messages, received and sent, from at least one of the user computer and computers.

31. The information-provisioning system of claim 30 wherein each representation of the email messages includes one or more of:
email addresses of recipients of the email message;
email address of a sender of the email message;
email addresses of recipients contained in a cc field of the email message;
email addresses recipients contained in a bcc field of the email message;
a subject of the email message;
descriptions of attachments included in the email message;
web-page or web-site links contained in the email message;
information extracted from the email-message text body;
a date or time when the message was sent;
a date or time when the message was received; and
a message identifier.

32. The information-provisioning system of claim 25 wherein the information-search component:
retrieves information from the data-storage component to order people with respect to importance;
uses information retrieved from the data-storage component to generate search queries for information related to a number of people having highest importance; and
searches for information related to people having highest importance available on the Internet, from RSS feeds, and from other electronic information sources using the generated search queries.

33. The information-provisioning system of claim 25 wherein the information-provision component provides to the user computer web pages containing information and from which the information provisioning system obtains user-supplied information.

34. The information-provisioning system of claim 33 wherein the web pages include:
a dashboard web page;
person-detail web pages;
company-detail web pages;
social-network graphs;
a companies-configuration web page; and
a people-configuration web page.

35. The information-provisioning system of claim 34 wherein the people-configuration web page includes a list of people, each person associated with an importance and a feature that allows the user to adjust the importance.

36. A method performed by one or more servers, the method comprising:
receiving information extracted from at least one of a user computer and computers accessible from the user computer, the extracted information extracted from applications at the at least one of the user computer and the computers;
storing the extracted information in a data-storage facility of the one or more servers;
retrieving from the data-storage facility at least part of the extracted information, to order information subjects with respect to importance of a person;
searching for information related to the information subjects having highest importance; and
providing at least part of the searched information from the search to the user computer.

37. The method of claim 36 further comprising computing an initial value of importance of a person further comprising dividing the number of emails sent by the user to the person by the number of email messages received by the user from the person, then multiplying the total number of email messages extracted from one or more user's email accounts to which the person is related.

38. The method of claim 37 further comprising recomputing the importance for information subjects on a fixed interval or on demand by the user.

39. The method of claim 36 wherein searching for information related to the information subjects having highest importance is ongoing.

40. The method of claim 36 wherein providing at least part of the searched information from the search to the user computer is on a continuous basis or in response to receiving a request from the user computer.

41. The method of claim 36 further including extracting information from representations of email messages received and sent from at least one of the user computer and the computers.

42. The method of claim 36 wherein each representation of the of email messages includes one or more of:
email addresses of recipients of the email message;
email address of a sender of the email message;
email addresses of recipients contained in a cc field of the email message;
email addresses recipients contained in a bcc field of the email message;
a subject of the email message;
descriptions of attachments included in the email message;
web-page or web-site links contained in the email message;
information extracted from the email-message text body;
a date or time when the message was sent;
a date or time when the message was received; and
a message identifier.

43. The method of claim 36 wherein retrieving information from the data-storage facility to order information subjects with respect to importance and searching for information related to a number of the information subjects having highest importance further includes:
retrieving information from a data-storage component to order people with respect to importance;
using information retrieved from a data-storage component to generate search queries for information related to people having highest importance; and
searching for information related to the people having highest importance available on the Internet, from RSS feeds, and from other electronic information sources using the generated search queries.

44. The method of claim 36 wherein providing information obtained by the information-search component to the user computer further comprises providing to the user web pages containing information and from which the information-provisioning system obtains user supplied information.

45. The method of claim 44 wherein the web pages include:
a dashboard web page;
person-detail web pages;
company-detail web pages;
social-network graphs;
a companies-configuration web page; and
a people-configuration web page.

46. The method of claim 45 wherein the people-configuration web page includes a list of people, each person associated with an importance and a feature that allows the user to adjust the importance.
